(19) United States
(12) Patent Application Publication
(10) Pub. No.: US 2025/0236739 A1
(43) Pub. Date: Jul. 24, 2025

(54) TWO-PART (2K) WATER-BORNE COATING COMPOSITION

(71) Applicant: AXALTA COATING SYSTEMS IP CO., LLC, Wilmington, DE (US)

(72) Inventors: Wiebke Becker, Essen (DE); Carmen Flosbach, Wuppertal (DE); Cen Lin, Claymont, DE (US); Jun Lin, Troy, MI (US); Mei Wen, Chesterbrook, PA (US)

(73) Assignee: AXALTA COATING SYSTEMS IP CO., LLC, Wilmington, DE (US)

(21) Appl. No.: 19/035,386

(22) Filed: Jan. 23, 2025

Related U.S. Application Data
(60) Provisional application No. 63/624,386, filed on Jan. 24, 2024.

(51) Int. Cl. C09D 5/16; C09D 133/06

(52) U.S. Cl. CPC C09D 5/1693; C09D 5/1662; C09D 133/066

(57) ABSTRACT

A two-part (2K) water-borne coating composition includes water; a) a binder part comprising (a1) a hydroxyl-functional (meth)acrylate copolymer; (a2) a non-aromatic polyester having active hydrogen groups; and b) a crosslinker part comprising a polyisocyanate compound having pendant —NCO groups, wherein the (a2) non-aromatic polyester has a number average molecular weight (Mn) of from 500 to 5000 Daltons, an acid value from 0 to 30 mg KOH/g, a calculated hydroxyl value of from 100 to t 600 mg KOH/g and a calculated hydroxyl functionality of from 2 to 8; and wherein the (a1) (meth)acrylate copolymer is the reaction product of a monomer mixture which comprises i) a hydroxyl functional adduct of a monoepoxyester and an unsaturated carboxylic acid; ii) a hydroxyl functional unsaturated monomer which is different from component i); iii) an unsaturated acid functional monomer; and iv) a (meth)acrylate monomer represented by Formula

H₂C═CG^{a}CO₂R^{a} (MA).

### CROSS-REFERENCE TO RELATED APPLICATIONS

This application claims the benefit of U.S. Provisional Application No. 63/624,386, filed Jan. 24, 2024.

### TECHNICAL FIELD

The present disclosure relates to a two-part (2K) water-borne coating composition including a binder part and a crosslinker part. The binder part comprises a water-dilutable hydroxyl-functional (meth)acrylate copolymer and a polyester having active hydrogen groups. The crosslinker part of the composition comprises at least one polyisocyanate compound having pendant —NCO groups. The coating composition can be used as a clear coating composition which is applied in vehicle finishing or refinishing.

### BACKGROUND

Automotive refinishing refers to compositions and processes used in the repair of a damaged automotive finish, typically but not necessarily an original equipment manufacturer (OEM) provided finish. For example, the damaged automotive component may contain defect area(s) wherein previously applied coating layers have been at least partially removed and such removal may in certain circumstances have exposed the bare substrates of the component. Refinish operations may thus involve the repair or replacement of the entire damaged automotive body component, the repair of one or more coating layers disposed on said components, or a combination of both operations. The size of the defect area and the presence or absence of coatings layers surrounding the defect area—which, if present, can act as anchors to refinishing coating compositions—are often determinative of the type of operation which is conducted.

As regards the repair of coating layers, the refinishing process generally comprises the sequential steps of: sanding the surface to be refinished; applying at least one layer of a primer composition; optionally, sanding the applied primer composition; applying at least one layer of a basecoat composition to achieve the desired optical appearance, such as the desired color, gloss or distinctiveness of image (DOI); and, applying a clear coat composition, which composition should be sufficiently transparent or translucent to enable the underlying coating layer(s) to be seen through it.

Historically, the coating compositions used in refinishing operations—including the clear coat compositions—have been solvent-borne and have thus contained significant amounts of volatile organic compounds (VOC). The use of such compounds is, however, regulated. For instance, in the United States, volatile organic compound emission standards are governed by Section 183(e) of the Clean Air Act (Act) and, as regards the enforceable emission levels for automobile refinish coatings, reference may be made to 42 United States Code (U.S.C.) § 7511b(e) and 40 Code of Federal Regulations (CFR) Part 59 Subpart B.

In recent times, the coatings industry has made significant strides in complying with state and federal regulations regarding VOC emissions through the development of high-solids solvent-based coating compositions and water-borne coating compositions.

Water-borne coating compositions can—vis-á-vis existing solvent-based alternatives—not only possess the desired wetting and levelling properties for refinishing applications but can concomitantly be readily applicable by users without the need for extensive re-purposing of existing application equipment. However, water-borne compositions must dehydrate for proper crosslinking and curing to occur. Given its boiling point, the removal of water can be difficult to achieve though flash drying because water removal conventionally requires quite stringent baking conditions in which the movement of air and the humidity of the oven or drying booth must be carefully controlled.

As the drying of water-borne compositions can present an energetic burden and can retard the refinishing process, volatile organic co-solvents or diluents have been incorporated into such compositions to mitigate their drying properties. However, going forward, the presence of such co-solvents and diluents may be undesirable in the event that the aforementioned regulations become more stringent with respect to permissible levels of VOCs in automobile refinish coating compositions.

It is therefore desirable to develop water-borne coating compositions which demonstrate comparable properties to their solvent-borne predecessors. More particularly, such water-borne compositions should exhibit good levelling on the application surface and be dehydratable—upon application—under moderate or low baking conditions. Further, such compositions should exhibit appropriate optical properties to facilitate their use in refinishing application and in particular as clear coating compositions thereof.

Additional beneficial features and characteristics of various compositions will become apparent from the subsequent detailed description and examples.

### BRIEF SUMMARY

The disclosure provides a two-part (2K) water-borne coating composition comprising:
water;
a binder part comprising:
   (a1) at least one water-dilutable hydroxyl-functional (meth)acrylate copolymer; and,
   (a2) at least one non-aromatic polyester having active hydrogen groups; and,
b) a crosslinker part comprising:
   at least one polyisocyanate compound having pendant —NCO groups,
wherein the molar ratio of active hydrogen atoms to —NCO groups in the composition is from about 5:1 to about 1:5;
wherein the (a2) non-aromatic polyester has a number average molecular weight (Mn) of from about 500 to about 5000 Daltons, an acid value from about 0 to about 30 mg KOH/g, a calculated hydroxyl value of from about 100 to about 600 mg KOH/g and a calculated hydroxyl functionality of from about 2 to about 8; and,
wherein the (a1) (meth)acrylate copolymer is the reaction product of monomers in a monomer mixture which comprises, based on the total weight of monomers:
   from about 20 to about 60 wt. % of i) at least one hydroxyl functional adduct of a monoepoxyester and an unsaturated carboxylic acid;
   from about 10 to about 30 wt. % of ii) at least one hydroxyl functional unsaturated monomer which is different from component i);
   from about 2 to about 6 wt. % of iii) at least one unsaturated acid functional monomer; and,
   from about 20 to about 60 wt. % iv) at least one (meth)acrylate monomer represented by Formula MA:

H₂C═CG^{a}CO₂R^{a} (MA)
wherein: G^{a} is hydrogen, halogen or methyl; and,
   R^{a} is: C₁-C₁₈ alkyl; C₂-C₁₈ heteroalkyl; C₃-C₁₈ cycloalkyl; C₂-C₈ heterocycloalkyl; C₂-C₈ alkenyl, or, C₂-C₈ alkynyl;
from about 0 to about 15 wt. % of v) at least one vinyl aromatic monomer; and,
from about 0 to about 20 wt. % of vi) at least one polymerizable unsaturated monomer that is different from i) to v).

The disclosure further provides a cured product obtained from the two-part (2K) water-borne coating composition.

The disclosure still further provides an article comprising: a metallic substrate; and, a multilayer coating disposed on the metallic substrate, wherein at least one layer of the multilayer coating comprises the cured product. In an important embodiment of the article, the multilayer coating comprises: a primer layer disposed on and in direct contact with the substrate; at least one base coat layer comprising a color and/or visual effect imparting compound, wherein a base coat layer is disposed on and in direct contact with the primer layer; and, a clear coat layer comprising the cured product, which clear coat layer is disposed on and in direct contact with a base coat layer.

Where the aspects of the disclosure are described herein as having certain embodiments, any one or more of those embodiments can, unless otherwise stated, be implemented in or combined with any one of the further embodiments, even if that combination is not explicitly described. Expressed differently, the described embodiments are not mutually exclusive unless stated as being such, and permutations thereof remain within the scope of this disclosure.

### BRIEF DESCRIPTION OF THE DRAWINGS

Various other objects, advantages, and features of the disclosure will become apparent to those skill in the art from the following discussion taken in conjunction with the appended drawings, in which:

FIG. 1 is a side cross-sectional view of an article in accordance with a first embodiment of the present disclosure; and,

FIG. 2 is a side cross-sectional view of an article in accordance with a second embodiment of the present disclosure.

### DETAILED DESCRIPTION

The following detailed description is merely exemplary in nature and is not intended to limit the present disclosure or the application and uses thereof. Furthermore, there is no intention to be bound by any theory presented in the preceding background or the following detailed description.

Embodiments of the present disclosure are generally directed to water-dilutable, hydroxyl functional (meth)acrylate copolymers, compositions including the same, and methods for forming the same. For the sake of brevity, conventional techniques related to making such polymers and such compositions may not be described in detail herein. Moreover, the various tasks and process steps described herein may be incorporated into a more comprehensive procedure or process having additional steps or functionality not described in detail herein. In particular, various steps in the manufacture of such polymers and associated compositions are well-known and so, in the interest of brevity, may conventional steps will only be described briefly or will be omitted entirely without providing the well-known process details.

The polymers and compositions disclosed herein may suitably comprise, consist of, or consist essentially of the components, elements, and process delineations described herein. The embodiments illustratively disclosed herein suitably may be practiced in the absence of any element which is not specifically disclosed herein.

### Definitions

The terminology “consists essentially of” may describe various non-limiting embodiments that are free of one or more optional compounds described herein or one or more additives, solvents, polymers, resins etc. that are not described herein but that are utilized in the art.

The terminology “about” can describe values ±0.1, 0.5, 1, 2, 3, 4, 5, 6, 7, 8, 9 or 10% in various embodiments. Moreover, it is considered that, in various non-limiting embodiments, it is to be appreciated that all numerical values as provided herein, save for actual examples, are approximate values with endpoints or particular values intended to read as “about” or “approximately” the values as recited.

The molecular weights referred to in this specification are typically measured with gel permeation chromatography (GPC) using polystyrene calibration standards, such as is done according to ASTM 3536.

As used herein, the “acid value” is the mass of potassium hydroxide (KOH) in milligrams that is required to neutralize one gram of the stated composition. The acid value can be determined by potentiometric analysis.

The term “hydroxyl value” as used herein is defined as the mass in milligrams of potassium hydroxide required to neutralize the acetic acid taken up on acetylation of one gram of a chemical substance that contains free hydroxyl groups. The hydroxyl value may be determined in accordance with DIN 53240.

The term “active hydrogen atoms” refers to hydrogen atoms which display activity according to the Zerewitinoff test as described by Kohlerin J. Am. Chem. Soc., 49, 3181 (1927), which is expressly incorporated herein by reference in its entirety in various non-limiting embodiments. Active hydrogen atoms can be derived from hydroxyl, thiol, primary amine, secondary amine and carboxyl groups.

As used herein, the term softening point (° C.) used in regard to waxes herein is the Ring & Ball softening point, which is measured unless otherwise indicated according to ASTM E28.

Viscosities of the compositions described herein are, unless otherwise stipulated, measured using the Brookfield Viscometer, Model CAP2000 at standard conditions of 20° C. and 50% Relative Humidity (RH). The viscometer is calibrated using hydrocarbon oils of known viscosities, which vary from 1 to 10,000 Centipoise. A set of RV spindles that attach to the viscometer are used for the calibration. Measurements of the coating compositions are done using the No. 4 spindle at a speed of 400 revolutions per minute for 1 minute until the viscometer equilibrates. The viscosity corresponding to the equilibrium reading is then calculated using the calibration.

Unless otherwise stated, the term “particle size” refers to the largest axis of the particle. In the case of a generally spherical particle, the largest axis is the diameter.

The term “mean volume particle size” (Dv50), as used herein, refers to a particle size corresponding to 50% of the volume of the sampled particles being greater than and 50% of the volume of the sampled particles being smaller than the recited Dv50 value. Similarly, if used, the term “Dv90” refers to a particle size corresponding to 90% of the volume of the sampled particles being smaller than and 10% of the volume of the sampled particles being greater than the recited Dv90 value. Particle size is determined herein by laser diffraction using Anton Paar Particle Size Analyzer (PSA) 1190.

As used herein, room temperature is 23° C. plus or minus 2° C.

As used herein, “ambient conditions” means the temperature and pressure of the surroundings in which the composition is located or in which a coating layer or the substrate of the coating layer is located.

“Two-part (2K) compositions” in the context of the present disclosure are understood to be compositions in which a first part a) and a second part b) are stored in separate vessels because of their (high) reactivity. The two parts are mixed only before or during application and then react, typically without additional activation, with bond formation and thereby formation of a polymeric network. Herein higher temperatures may be applied in order to accelerate the cross-linking reaction.

The term “water-dilutable (co)polymer” as used herein refers to a (co)polymer that exists in the form of particles in water, the particles being dispersed or suspended and being generally stable against flocculation upon further dilution with water. In contrast to a water-soluble (co)polymer, a dilute solution (about 1 g/L) of a water-dilutable polymer exhibits scattering when analyzed using dynamic light scattering or any other technique well known in the art of particle analysis.

The term “clear coat” is used herein to denote a coating layer within a multilayer coating which is sufficiently transparent or translucent to enable the underlying coating layer(s) to be seen through it. The term “clear” does not require absolute transparency or translucency.

As used herein, “metallic” means any type of metal, metal alloy, or mixture thereof. As used herein, the term “alloy” refers to a substance composed of two or more metals or of a metal and a non-metal which have been intimately united, usually by being fused together and dissolved in each other when molten.

As used herein, the term “catalytic amount” means a sub-stoichiometric amount of catalyst relative to a reactant, except where expressly stated otherwise.

As used herein, the term “free radical initiator” refers to compounds which, upon exposure to sufficient energy—in the form of light or heat, for example—decomposes into parts which are uncharged, but which each possess at least one unpaired electron. In particular, a free radical thermal initiator generates free radicals upon activation by thermal energy upon, for instance, heating or irradiation of the infrared or microwave wavelength regions.

All isomers and chiral options for each compound described herein are expressly contemplated for use herein in various non-limiting embodiments.

It will be understood that the subscripts of polymers are typically described as average values because the synthesis of polymers typically produces a distribution of various individual molecules.

As used herein, the term “monomer” refers to a substance that can undergo a polymerization reaction to contribute constitutional units to the chemical structure of a polymer. The term “monofunctional”, as used herein, refers to the possession of one polymerizable moiety. The term “polyfunctional”, as used herein, refers to the possession of more than one polymerizable moiety.

The term “blocked” as used herein refers to a compound possessing a “blocking group” such that its reactive functionality is not available until such time as the blocking group is removed or degraded. The blocking group can be selectively removed or degraded at an appropriate point in the synthetic sequence: the triggering event may be inter alia moisture, heat or irradiation. Examples of blocked isocyanates include those that have been co-reacted with phenol, methyl ethyl ketoxime or ε-caprolactam.

The term “fatty acid” as used herein, is a monocarboxylic acid composed of an aliphatic chain that includes from 4 to 22 carbon atoms with a terminal carboxyl group (COOH). The fatty acid can be saturated or unsaturated, branched or unbranched, and may or may not include one or more hydroxyl group(s). Exemplary fatty acids include: linoleic acid; oleic acid; stearic acid; palmitic acid; dihydroxystearic acid; linolenic acid; and, eiconsanoic acid.

The term “dimerfatty acid” is interchangeable with “dimerizedfatty acid” and refers generally to a compound including two fatty acid subunits in which the respective fatty acid side chains are covalently bound to each other, via a bond or a linking group. Thus, as described herein, a dimer fatty acid dimer is a covalent fatty dimer. The dimer fatty acid can be a heterodimer or a homodimer and may be cyclic or non-cyclic. The term is intended to encompass derivatives of dimer fatty acids which possess functional carboxyl groups which perform substantially like dicarboxylic acids in reaction with glycols and diols in forming polyesters: mention may be made of esters and ester forming reactive derivatives such as acid halides and anhydrides.

As used herein, “(meth)acryl” is a shorthand term referring to “acryl” and/or “methacryl”. Thus the term “(meth)acrylamide” refers collectively to acrylamide and methacrylamide.

As used herein, “C₁-Cₙ alkyl” refers to a monovalent group or moiety having from 1 to n carbons atoms, that is a radical of an alkane and includes straight-chain and branched organic groups. As such, a “C₁-C₁₈ alkyl” refers to a monovalent group or moiety having from 1 to 18 carbons atoms, that is a radical of an alkane and includes straight-chain and branched organic groups. Examples of alkyl groups include: methyl; ethyl; propyl; isopropyl; n-butyl; isobutyl; sec-butyl; tert-butyl; n-pentyl; n-hexyl; n-heptyl; and, 2-ethylhexyl. In the present disclosure, such alkyl groups may be unsubstituted or may be substituted with one or more halogen. Where applicable for a given moiety (R), a tolerance for one or more non-halogen substituents within an alkyl group will be described in the specification.

The term “C₁-C₁₈ hydroxyalkyl” as used herein refers to an HO-(alkyl) group having from 1 to 18 carbon atoms, where the point of attachment of the substituent is through the oxygen-atom and the alkyl group is as defined above.

An “alkoxy group” refers to a monovalent group represented by —OA where A is an alkyl group: non-limiting examples thereof are a methoxy group, an ethoxy group and an iso-propyloxy group. The term “C₁-C₁₈ alkoxyalkyl” as used herein refers to an alkyl group or moiety having an alkoxy substituent as defined above and wherein the moiety (alkyl-O-alkyl) has in total from 1 to 18 carbon atoms: such groups include methoxymethyl (—CH₂OCH₃), 2-methoxyethyl (—CH₂CH₂OCH₃) and 2-ethoxyethyl. Analogously, the term “C₇-C₁₈ alkoxyaryl” as used herein refers to an aryl group having an alkoxy substituent as defined above and wherein the moiety (aryl-O-alkyl) comprises in total from 7 to 18 carbon atoms.

The term “C₂-C₄ alkylene” as used herein, is defined as saturated, divalent hydrocarbon radical having from 2 to 4 carbon atoms.

The term “C₃-C₁₈ cycloalkyl” encompasses a saturated, mono- or polycyclic hydrocarbon group or moiety having from 3 to 18 carbon atoms. In the present disclosure, such cycloalkyl groups or moieties may be unsubstituted or may be substituted with one or more halogen. Where applicable for a given moiety (R), a tolerance for one or more non-halogen substituents within a cycloalkyl group will be noted in the specification. Examples of cycloalkyl groups include: cyclopropyl; cyclobutyl; cyclopentyl; cyclohexyl; cycloheptyl; cyclooctyl; adamantane; and, norbornane.

As used herein, “C₂-C₁₈ alkenyl” refers to hydrocarbyl groups or moieties having from 2 to 18 carbon atoms and at least one unit of ethylenic unsaturation. The alkenyl group or moiety can be straight chained, branched or cyclic and may optionally be substituted with one or more halogen. Where applicable for a given moiety (R), a tolerance for one or more non-halogen substituents within an alkenyl group will be noted in the specification. The term “alkenyl” also encompasses radicals having “cis” and “trans” configurations, or alternatively, “E” and “Z” configurations, as appreciated by those of ordinary skill in the art. Examples of C₂-C₂₀ alkenyl groups include: —CH═CH₂; —CH═CHCH₃; —CH₂CH═CH₂; —C(═CH₂)(CH₃); —CH═CHCH₂CH₃; —CH₂CH═CHCH₃; —CH₂CH₂CH═CH₂; —CH═C(CH₃)₂; —CH₂C(═CH₂)(CH₃); —C(═CH₂)CH₂CH₃; —C(CH₃)═CHCH₃; —C(CH₃)CH═CH₂; —CH═CHCH₂CH₂CH₃; —CH₂CH═CHCH₂CH₃; —CH₂CH₂CH═CHCH₃; —CH₂CH₂CH₂CH═CH₂; —C(═CH₂)CH₂CH₂CH₃; —C(CH₃)═CHCH₂CH₃; —CH(CH₃)CH═CHCH; —CH(CH₃)CH₂CH═CH₂; —CH₂CH═C(CH₃)₂; 1-cyclopent-1-enyl; 1-cyclopent-2-enyl; 1-cyclopent-3-enyl; 1-cyclohex-1-enyl; 1-cyclohex-2-enyl; and, 1-cyclohexyl-3-enyl.

As used herein, “C₆-C₁₈ aryl” used alone or as part of a larger moiety—as in “aralkyl group”—refers to monocyclic, bicyclic and tricyclic ring systems in which the monocyclic ring system is aromatic or at least one of the rings in a bicyclic or tricyclic ring system is aromatic. The bicyclic and tricyclic ring systems include benzofused 2-3 membered carbocyclic rings. In the present disclosure, such aryl groups may be unsubstituted or may be substituted with one or more halogen. Where applicable for a given moiety (R), a tolerance for one or more non-halogen substituents within an aryl group will be noted in the specification. Exemplary aryl groups include: phenyl; (C₁-C₄)alkylphenyl, such as tolyl and ethylphenyl; indenyl; naphthalenyl; tetrahydronaphthyl, tetrahydroindenyl; tetrahydroanthracenyl; and, anthracenyl.

As used herein, “alkylaryl” refers to alkyl-substituted aryl groups or moieties and “substituted alkylaryl” refers to alkylaryl groups or moieties further bearing one or more substituents as set forth above. Further, as used herein “aralkyl” means an alkyl group or moiety substituted with an aryl radical as defined above.

The term “hetero” as used herein refers to groups or moieties containing one or more heteroatoms, such as N, O, Si and S. Thus, for example “heterocyclic” refers to cyclic groups having, for example, N, O, Si or S as part of the ring structure. “Heteroalkyl”, “heterocycloalkyl” and “heteroaryl” moieties are alkyl, cycloalkyl and aryl groups as defined hereinabove, respectively, containing N, O, Si or S as part of their structure.

The term “non-polymeric” is used herein as a descriptor of a compound that is not made up from repeating structural units. A non-polymeric compound can be considered as a unique, single structural unit.

The term “non-aromatic”, when applied herein as a descriptor for monomers, refers to a compound which does not possess an aromatic nucleus. The term is intended to include both aliphatic and cycloaliphatic compounds which may be saturated or unsaturated, in the latter case containing non-aromatic carbon-carbon double bonds or carbon-carbon triple bonds. Non-aromatic polymeric compounds can be substantially free of aromatic nuclei in their backbone such that the polymer may contain aromatic nuclei only by virtue of technical impurities of aliphatic or cycloaliphatic monomeric building blocks.

The term “base” as used herein refers to a species: which is capable of abstracting a proton in either a polar or non-polar solvent; or, which is capable of donating a hydroxide anion (OH⁻).

In various embodiments, the term “free of” describes embodiments that include less than about 5, 4, 3, 2, 1, 0.5 or 0.1 wt. % of the component, compound, moiety, functional group, element or ion at issue using an appropriate weight basis as would be understood by one of skill in the art. In other embodiments, the term “free of” describes embodiments that have about 0 wt. % of the component, compound, moiety, functional group, element or ion at issue.

The term “anhydrous” as used herein has equivalence to the term “free of water”.

Referring back, the water-borne composition comprises water and: a) a binder part; and, b) a crosslinker part. The water can be present in an amount of from 30 to 80 wt. %, based on the weight of the composition. For example, the water may be present in an amount of from 35 to 70 wt. %, from 40 to 60 wt. %, from 45 to 55 wt. %, from 45 to 52 wt. % or from 46 to 51 wt. %. At this water content, the drying and coalescing of the composition—when applied to a substrate—may not be associated with high energetic and time costs. Compositions having this water content may be exemplified by a viscosity less than 500 Centipoise, less than 200 Centipoise, less than 100 Centipoise, less than 50 Centipoise, less than 40 Centipoise or even less than 30 Centipoise, as measured at room temperature. In various non-limiting embodiments, all values and ranges of values, both whole and fractional, including and between those set forth above are expressly contemplated for use herein.

The water of the two-part (2K) composition need not be added independently to any one or more components or to the composition itself. Alternatively, one or more of the components of the composition may be provided in water.

In certain embodiments, the binder part a) of the two-part (2K) composition comprises water such that said binder part a) provides at least a fraction of the water of the two-part (2K) composition. It is not precluded however that supplementary water be added to the composition during or after a binder part a) comprising water and the crosslinker part b) are brought together. The addition of this supplementary water may serve to reduce the viscosity of the composition, which may be useful for certain methods described below by which the composition is applied to substrates, such as spraying.

### Part A)

Referring now to the binder part a) of the two-part water-borne composition, this part comprises: (a1) at least one water-dilutable hydroxyl functional (meth)acrylic copolymer; and, (a2) at least one non-aromatic polyester having active hydrogen groups.

The at least one hydroxyl-functional (meth)acrylate copolymer of constituent (a1) is water-dilutable but typically is compatible with polyisocyanates, including hydrophobic polyisocyanates which have not been hydrophilically modified with inter alia polyether or polyester groups. As such, the two-part coating composition is itself water-dilutable, which can present flexibility for an operator when applying the coating compositions in, for instance, vehicle refinishing operations. Moreover, it is considered that amount of vinyl aromatic monomers promotes the miscibility of the hydroxyl-functional (meth)acrylate copolymer with the polyisocyanate, thereby maintaining the dispersion stability of that copolymer and providing a better appearance to the final cured coating.

The presence of the non-aromatic polyester in the binder part of the composition improves the appearance of the cured coatings obtained therefrom. The non-aromatic polyester may also contribute to the cured coatings demonstrating resistance to weathering.

### Co-Polymer Constituent (a1)

The (meth)acrylate copolymer is the reaction product of a monomer mixture which comprises, based on the total weight of monomers of the monomer mixture:
from 20 to 60 wt. % of i) at least one hydroxyl functional adduct of a monoepoxyester and an unsaturated carboxylic acid;
from 10 to 30 wt. % of ii) at least one hydroxyl functional unsaturated monomer which is different from component i);
from 2 to 6 wt. % of iii) at least unsaturated acid functional monomer;
from 20 to 60 wt. % of iv) at least one (meth)acrylate monomer represented by Formula MA:

H₂C═CG^{a}CO₂R^{a} (MA)
wherein: G^{a} is hydrogen, halogen or methyl; and,
   R^{a} is: C₁-C₁₈ alkyl; C₂-C₁₈ heteroalkyl; C₃-C₁₈ cycloalkyl; C₂-C₁₈ heterocycloalkyl; C₂-C₈ alkenyl, or, C₂-C₈ alkynyl;
from 0 to 15 wt. % of v) at least one vinyl aromatic monomer; and,
from 0 to 20 wt. % of vi) at least one polymerizable unsaturated monomer that is different from monomer components i) to v).

### Monomer Component i): Hydroxyl Functional Adduct

The monomer mixture includes, based on the total weight of the monomers in the monomer mixture, from 20 to 60 wt. % of i) at least one hydroxyl functional adduct of a monoepoxyester and an unsaturated carboxylic acid. For example, the monomer mixture may comprise, based on the total weight of the monomers in the monomer mixture, from 30 to 60 wt. % or from 40 to 60 wt. % of i) the at least one adduct. In various non-limiting embodiments, all values and ranges of values, both whole and fractional, including and between those set forth above are expressly contemplated for use herein.

Typically the adduct is formed via a nucleophilic addition reaction of the monoepoxyester with the acid to form a hydroxyalkyl ester. This acidolysis ring-opening reaction conventionally requires a catalyst, of which tertiary amines, quaternary ammonium compounds and transition metals compounds may be mentioned as examples.

The reactant monoepoxyesters are typically glycidyl esters derived from aliphatic saturated monocarboxylic acids having a tertiary or quaternary carbon atom in the alpha (α-) position. Representative reactant monoepoxyesters are the glycidyl esters of saturated α,α-dialkylalkane-monocarboxylic acids having from 5 to 13 carbons atoms or from 9 to 11 carbon atoms in the acid molecule. Exemplary reactant monoepoxyesters include: versatic acid glycidylester available commercially as Cardura E10 from Hexion; pivalic acid glycidylester, available commercially as Cardura E5 from Hexion; and, the reaction product of a tertiary fatty acid up to 12 carbon atoms and epichlorohydrin.

The reactant acid functional compound can be aliphatic unsaturated monocarboxylic acids, of which non-limiting examples include: α,β-monoethylenically unsaturated monocarboxylic acids, such as acrylic acid, methacrylic acid, crotonic acid and isocrotonic acid; C₁-C₆ alkyl half-esters of α,β-monoethylenically unsaturated dicarboxylic acids, such as fumaric acid and maleic acid; and, C₁-C₆ alkyl esters of α,β-monoethylenically unsaturated tricarboxylic acids bearing one free carboxylic acid group. In various embodiments, acrylic acid and/or methacrylic acid as the reactant acid functional compound.

### Monomer Component ii): Hydroxyl Functional Ethylenically Unsaturated Monomer

The monomer mixture comprises, based on the total weight of the monomers in the monomer mixture, from 10 to 30 wt. % of ii) at least one hydroxyl functional monomer which is different from monomer component i). For example, the monomer mixture may comprise, based on the total weight of the monomers in the monomer mixture, from 10 to 25 wt. % or from 10 to 20 wt. % of ii) the at least one hydroxyl functional monomer. In various non-limiting embodiments, all values and ranges of values, both whole and fractional, including and between those set forth above are expressly contemplated for use herein.

Exemplary monomers of component ii) include hydroxyalkyl esters with primary or secondary hydroxyl groups derived from α,β-monoethylenically unsaturated monocarboxylic acids. These can include, for instance, hydroxyalkyl esters derived from acrylic acid, methacrylic acid, crotonic acid or iso-crotonic acid.

In an embodiment, monomer component ii) comprises at least one hydroxyl (meth)acrylate monomer represented by Formula HMA:

H₂C═CG^{a}CO₂R^{h} (HMA)
wherein: G^{a} is hydrogen, halogen or methyl; and,
   R^{h} is C₁-C₁₈ hydroxyalkyl.

Typical monomers in accordance with Formula HMA are those wherein: G^{a} is hydrogen, halogen or methyl; and, R^{h} is C₁-C₁₂ hydroxyalkyl. Monomers in which G^{a} is hydrogen or methyl and R^{h} is C₁-C₆ hydroxyalkyl may also be used.

Examples of (meth)acrylate monomers in accordance with Formula HMA include: hydroxyethyl (meth)acrylate; 1-hydroxypropyl (meth)acrylate; 2-hydroxypropyl (meth)acrylate; 1-hydroxybutyl (meth)acrylate; 2-hydroxybutyl (meth)acrylate; and, 3-hydroxybutyl (meth)acrylate.

Monomer Component iii): Ethylenically Unsaturated Acid Functional Monomer

The monomer mixture also comprises, based on the total weight of the monomers in the monomer mixture, from 2 to 6 wt. % of iii) at least one ethylenically unsaturated acid functional monomer. For example, component iii) may constitute from 2 to 5 wt. % or from 2 to 4 wt. % of the monomer mixture. In various non-limiting embodiments, all values and ranges of values, both whole and fractional, including and between those set forth above are expressly contemplated for use herein.

Without intention to limit the present disclosure, the unsaturated acid functional monomers can be chosen from: ethylenically unsaturated carboxylic acids; ethylenically unsaturated sulfonic acids; vinylphosphonic acid; and, mixtures thereof. Suitable ethylenically unsaturated sulfonic acids include, for instance, vinylsulfonic acid, styrenesulfonic acid and acrylamidomethylpropanesulfonic acid.

Typically monomer component iii) comprises at least one ethylenically unsaturated carboxylic acid chosen from: α,β-monoethylenically unsaturated monocarboxylic acids; α,β-monoethylenically unsaturated dicarboxylic acids; C₁-C₆ alkyl half-esters of α,β-monoethylenically unsaturated dicarboxylic acids; α,β-monoethylenically unsaturated tricarboxylic acids; C₁-C₆ alkyl esters of α,β-monoethylenically unsaturated tricarboxylic acids bearing at least one free carboxylic acid group; and, mixtures thereof. In particular, the monomer component iii) can comprise at least one ethylenically unsaturated carboxylic acid chosen from methacrylic acid, acrylic acid, itaconic acid, maleic acid, aconitic acid, crotonic acid, fumaric acid and mixtures thereof.

For completeness, whilst the above-described unsaturated acid functional monomer can be used in the form of free acid, it is not precluded that the constituent acid groups of the monomers be partially or completely neutralized with suitable bases, provided this does not compromise their participation in the co-polymerization reaction.

### Monomer Component iv): (Meth)Acrylate Monomers of Formula MA

The monomer mixture also comprises, based on the total weight of the monomers in the monomer mixture, from 20 to 60 wt. % of iv) at least one (meth)acrylate monomer represented by Formula MA:

H₂C═CG^{a}CO₂R^{a} (MA)
wherein: G^{a} is hydrogen, halogen or methyl; and,
   R^{a} is: C₁-C₁₈ alkyl; C₂-C₁₈ heteroalkyl; C₃-C₈ cycloalkyl; C₂-C₈ heterocycloalkyl; C₂-C₈ alkenyl; or, C₂-C₈ alkynyl.

For example, the monomer mixture may comprise, based on the total weight of the monomers in the monomer mixture, from 25 to 50 wt. % of iv) the at least one (meth)acrylate monomer represented by Formula MA. In various non-limiting embodiments, all values and ranges of values, both whole and fractional, including and between those set forth above are expressly contemplated for use herein.

In typical monomers in accordance with Formula MA: G^{a} is hydrogen, halogen or methyl; and, R^{a} is C₁-C₁₈ alkyl or C₃-C₁₈ cycloalkyl. Monomers in which G^{a} is hydrogen or methyl may also be used.

Examples of (meth)acrylate monomers in accordance with Formula MA, which may be used alone or in combination, include: methyl (meth)acrylate; ethyl (meth)acrylate; n-butyl (meth)acrylate; isobutyl (meth)acrylate; hexyl (meth)acrylate; 2-ethylhexyl (meth)acrylate; isodecyl (meth)acrylate; dodecyl (meth)acrylate; lauryl (meth)acrylate; stearyl (meth)acrylate; cyclohexyl (meth)acrylate; 3,3,5-trimethylcyclohexyl (meth)acrylate; 4-tert-butyl cyclohexyl (meth)acrylate; isobornyl (meth)acrylate; norbornyl (meth)acrylate; dihydrodicyclopentandienyl (meth)acrylate; ethylene glycol monomethyl ether (meth)acrylate; ethylene glycol monoethyl ether (meth)acrylate; ethylene glycol monododecyl ether (meth)acrylate; diethylene glycol monomethyl ether (meth)acrylate; trifluoroethyl (meth)acrylate; and, perfluorooctyl (meth)acrylate.

The (meth)acrylate monomers constituting component iv) of the monomer mixture may, in some embodiments, comprise “hard” monomers. The terminology “hard monomer” typically describes a monomer which, if homopolymerized, would yield a homopolymer having a glass transition temperature (Tg) of greater than about 30° C. For example, the monomer component iv) may comprise at least one (meth)acrylate monomer which would be considered a hard monomer.

Exemplary hard monomers include: cyclohexyl (meth)acrylate; 3,3,5-trimethylcyclohexyl (meth)acrylate; isobornyl (meth)acrylate; norbornyl (meth)acrylate; dihydrodicyclopentandienyl (meth)acrylate; and, 4-tert-butyl cyclohexyl (meth)acrylate.

### Monomer Component v): Optional Vinyl Aromatic Monomers

The monomer mixture may also comprise, based on the total weight of the monomers in the monomer mixture, from 0 to 15 wt. % of v) at least one vinyl aromatic monomer. For example, the monomer mixture may comprise, based on the total weight of the monomers in the monomer mixture, from 4 to 14 wt. %, from 8 to 14 wt. % or from 10 to 14 wt. % of v) the at least one vinyl aromatic monomer. Alternatively, this monomer may be excluded entirely. In various non-limiting embodiments, all values and ranges of values, both whole and fractional, including and between those set forth above are expressly contemplated for use herein.

In an embodiment, monomer component v) comprises at least one vinyl aromatic monomer of Formula (VA):

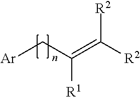

wherein: R¹ is H or C₁-C₄ alkyl;
   each R² is independently hydrogen or C₁-C₄ alkyl;
   Ar is unsubstituted phenyl or phenyl substituted with from 1 to 5 substituents, wherein each substituent is independently halogen or C₁-C₄ alkyl; and,
   n is an integer from 0 to 4.

Typical monomers in accordance with Formula VA are those wherein: R¹ is H or methyl; each R² is independently H or methyl; Ar is unsubstituted phenyl or phenyl substituted with from 1 to 5 substituents, wherein each substituent is independently halogen or C₁-C₄ alkyl; and, n is 0 or 1.

Exemplary vinyl aromatic monomers in accordance with Formula (VA)—which may be used alone or in combination—include: styrene; α-methylstyrene; 2-methylstyrene; 3-methylstyrene; 4-methylstyrene; 2-tert-butyl styrene; 4-tert-butylstyrene; 2-chlorostyrene; and, 4-chlorostyrene.

### Monomer Component vi): Optional Further Monomers

The monomer mixture may also comprise, based on the total weight of the monomers in the monomer mixture, from 0 to 25 wt. % of at least one polymerizable unsaturated monomer that is different from monomer components i) to v). For example, the monomer mixture may comprise, based on the total weight of the monomers in the monomer mixture, from 0 to 20 wt. %, from 1 to 20 wt. % or from 5 to 20 wt. % of the at least one polymerizable unsaturated monomer that is different from monomer components i) to v). In various non-limiting embodiments, all values and ranges of values, both whole and fractional, including and between those set forth above are expressly contemplated for use herein.

Exemplary monomers of component vi), which may be used alone or in combination, include: aromatic (meth)acrylate monomers; (meth)acrylate functionalized oligomers; nitrogen (N—) functionalized ethylenically unsaturated monomer; silane-functional ethylenically unsaturated monomers, such as methacryloxypropyl tri(C₁-C₅)alkoxysilanes and vinyl tri(C₁-C₅)alkoxysilanes; acetoacetyl-functional unsaturated monomers, such as acetoacetoxy ethylmethacrylate; vinyl esters; vinyl and vinylidene halides; vinyl ethers; alkyl vinyl ketones; cycloalkyl vinyl ketones; heterocyclic aliphatic vinyl compounds; poly(meth)acrylates of alkane polyols; poly(meth)acrylates of oxyalkane polyols; and, poly(C₂-C₃)alkylene glycol di(meth)acrylates.

Suitable aromatic (meth)acrylate monomers include those represented by Formula AII:

H₂C═CG^{b}CO₂R^{b} (AII)
wherein: G^{b} is hydrogen, halogen or methyl; and,
   R^{b} is C₆-C₁₈ aryl, C₁-C₉ heteroaryl, C₇-C₁₈ alkoxyaryl, C₇-C₁₈ alkaryl or C₇-C₁₈ aralkyl.

Exemplary (meth)acrylate monomers in accordance with Formula (AII)—which may be used alone or in combination—include: benzyl (meth)acrylate; phenoxyethyl (meth)acrylate; and, phenoxypropyl (meth)acrylate.

Suitable (meth)acrylate functionalized oligomers may be chosen from (meth)acrylate-functionalized polyurethanes, (meth)acrylate-functionalized polybutadienes, (meth)acrylic polyol (meth)acrylates, polyester (meth)acrylate oligomers, polyamide (meth)acrylate oligomers, polyether (meth)acrylate oligomers and mixtures thereof. The oligomers may have one or more acrylate and/or methacrylate groups attached to the oligomeric backbone, which (meth)acrylate functional groups may be in a terminal position on the oligomer and/or may be distributed along the oligomeric backbone. It is typical that the (meth)acrylate functionalized oligomer reacted as a monomer in deriving the copolymer (a1): has two or more (meth)acrylate functional groups per molecule; and/or, has a weight average molecular weight (Mw) of from about 300 to about 1000 Daltons. In various non-limiting embodiments, all values and ranges of values, both whole and fractional, including and between those set forth above are expressly contemplated for use herein.

With regard to (N—) functionalized ethylenically unsaturated monomers, the nitrogen functionalized groups may either be nitrile or urea or may include imidic, amidic or aminic nitrogen atoms.

Exemplary nitrile monomers include acrylonitrile and methacrylonitrile. Exemplary maleimide monomers include: maleimide; methylmaleimide; ethylmaleimide; propylmaleimide; butylmaleimide; hexylmaleimide; octylmaleimide; dodecylmaleimide; stearylmaleimide; phenylmaleimide; and, cyclohexylmaleimide. Exemplary (meth)acrylamides include: acryloyl morpholine; diacetone (meth)acrylamide; N-methyl (meth)acrylamide; N-ethyl (meth)acrylamide; N-isopropyl (meth)acrylamide; N-t.butyl (meth)acrylamide; N-hexyl (meth)acrylamide; N-cyclohexyl (meth)acrylamide; N-octyl (meth)acrylamide; N-t.octyl (meth)acrylamide; N-dodecyl (meth)acrylamide; N-benzyl (meth)acrylamide; N-(hydroxymethyl)acrylamide; N-isobutoxymethyl acrylamide; N-butoxymethyl acrylamide; N,N-dimethyl (meth)acrylamide; N,N-diethyl (meth)acrylamide; N,N-propyl (meth)acrylamide; N,N-dibutyl (meth)acrylamide; N,N-dihexyl (meth)acrylamide; N,N-dimethylamino methyl acrylamide; N,N-dimethylamino ethyl acrylamide; N,N-dimethylamino propyl acrylamide; N,N-dimethylamino hexyl acrylamide; N,N-diethylamino methyl acrylamide; N,N-diethylamino ethyl acrylamide; N,N-diethylamino propyl acrylamide; N,N-dimethylamino hexyl acrylamide; N-hydroxymethyl (meth)acrylamide; acrylamido-2-methylpropanesulfonate; and, N,N′-methylenebisacrylamide.

The inclusion in the copolymer(s) (a1) of the residue of at least one amino (meth)acrylate monomer is not precluded. As used herein, the term “amino (meth)acrylate” refers to a derivative of methacrylic acid or acrylic acid that has a primary, secondary, or tertiary amino group: the amino group can be part of a linear, branched or cyclic aliphatic group or an aromatic group. The at least one amino (meth)acrylate monomer can be a tertiary amino (meth)acrylate, such as, in particular, an N,N-dialkylaminoalkyl(meth)acrylate. In various embodiments, one or more of N,N-dimethylaminoethylmethacrylate, N,N-dimethylaminoethylacrylate, N,N-dimethylaminopropylmethacrylate or N,N-dimethylaminopropylacrylate may be used.

In a further non-limiting embodiment, the monomer mixture includes at least one vinyl monomer having a nitrogen heterocyclic structure. Exemplary heterocyclic structures have either 5- or 6-members and may comprise oxygen atoms in addition to nitrogen: the 5- or 6-membered ring may, for instance, represent a pyridine, pyrimidine, pyridazine, imidazoline, imidazole, oxazoline, oxazole or morpholine ring. Examples, which may be used alone or in combination, include: N-vinylcaprolactam (NVC); vinyl methyl oxazolidinone (VMOX); N-vinylformamide; N-vinylcarbazole; N-vinylacetamide; and, N-vinylpyrrolidone.

Exemplary vinyl esters which may be copolymerized in the present disclosure include vinyl acetate, vinyl propionate, vinyl pivalate, vinyl benzoate and monomers of the VEOVA™ series available from Shell Chemical Company. Exemplary poly(meth)acrylates of alkane polyols which may be copolymerized include ethylene glycol di(meth)acrylate, propylene glycol di(meth)acrylate, butylene glycol di(meth)acrylate, neopentyl glycol di(meth)acrylate, hexylene glycol di(meth)acrylate, trimethylolpropane tri(meth)acrylate, glycerin tri(meth)acrylate and pentaerythritol tetra(meth)acrylate. Exemplary poly(meth)acrylates of oxyalkane polyols which may be copolymerized include diethylene glycol di(meth)acrylate, dipropylene glycol di(meth)acrylate, triethylene glycol di(meth)acrylate, tetraethylene glycol di(meth)acrylate, dibutylene glycol di(meth)acrylate, di(pentamethylene glycol)dimethacrylate.

In one embodiment, the monomer mixture comprises at least one monomer having the general formula AM1:

R⁴—C(H)═C(R⁵)-A-(R⁶O)_{[a]}—R⁷ (AM1)
wherein: R⁴ is H, methyl, CO₂H or CH₂CO₂H;
   R⁵ is hydrogen, halogen or methyl;
   A is —CH₂C(O)O—, —C(O)O—, —O—, —CH₂O—, —CH₂C(O)N—, —C(O)N—, —CH₂—, —O—C(O)—, —NHC(O)O—, —NHC(O)NH—, —C₆H₄(R⁸)—NH—C(O)—O—, —C₆H₄(R⁸)—NH—C(O)—NH—, —C(O)O—CH₂—CH(CH₂OH)—O—, —C(O)O—CH₂—CH(CH₂OH)—NH—, —C(O)O—CH₂—CH₂—CH(OH)—O—, —C(O)O—CH₂—CH₂—CH(OH)—NH—, —CH₂—O—CH₂—CH(CH₂OH)—O—, —CH₂—O—CH₂—CH₂—CH(OH)—O—, —CH₂—O—CH₂—CH(CH₂OH)—NH—, or —CH₂—O—CH₂—CH₂—CH(OH)—NH—;
   each R⁶ is independently C₂-C₄ alkylene;
   [a] has a value of from 5 to 100;
      R⁷ is C₁-C₃₀ alkyl, C₁-C₃₀ hydroxyalkyl, C₁-C₃₀ aminoalkyl, C₃-C₁₈ cycloalkyl, C₂-C₅heterocycloalkyl, C₂-C₂₀ alkenyl, C₂-C₁₂ alkynyl, C₆-C₁₈ aryl, C₇-C₂₄ alkaryl or C₇-C₂₄ aralkyl; and,
   R⁸ is —CH₂— or —(C)(CH₃)₂—.

Typical monomers in accordance with Formula AM1 are those wherein: R⁴ is H, methyl, CO₂H or CH₂CO₂H; R⁵ is hydrogen, halogen or methyl; A is —CH₂C(O)O— or —C(O)O—; each R⁶ is independently C₂-C₄ alkylene; [a] has a value of from 10 to 30; and, R⁷ is C₆-C₃₀ alkyl, C₆-C₃₀ hydroxyalkyl, C₆-C₃₀ aminoalkyl, C₃-Cis cycloalkyl, C₆-C₁₈ aryl, C₇-C₁₈ alkaryl or C₇-C₁₈ aralkyl.

Representative monomers in accordance with Formula AM1 are those wherein: R⁴ is H, methyl, CO₂H or CH₂CO₂H; R⁵ is hydrogen, halogen or methyl; A is —C(O)O—; each R⁶ is independently C₂-C₃ alkylene; [a] has a value of from 10 to 30; and, R⁷ is C₆-C₃₀ alkyl, C₆-C₃₀ hydroxyalkyl or C₆-C₃₀ aminoalkyl.

Exemplary monomers in accordance with Formula AM1, which may be co-polymerized alone or in combination, include: lauryl ethoxylate [a] (meth)acrylate; cetyl ethoxylate [a] (meth)acrylate; stearyl ethoxylate [a] (meth)acrylate; behenyl ethoxylate [a] (meth)acrylate; lauryl ethoxylate [a] itaconate; cetyl ethoxylate [a] itaconate; stearyl ethoxylate [a] itaconate; behenyl ethoxylate [a] itaconate; lauryl ethoxylate [a] maleate; cetyl ethoxylate [a] maleate; stearyl ethoxylate [a] maleate; and, behenyl ethoxylate [a] maleate, wherein [a] represents the number of moles of ethoxylation and has a value of from 10 to 30. In other words, each of the above may be described as an ethoxylated compound that has a degree of ethoxylation of from 10 to 30 moles of ethylene oxide. The parameter [a] may, in certain embodiments, have a value of from 15 to 30 or from 15 to 25. In various non-limiting embodiments, all values and ranges of values, both whole and fractional, including and between those set forth above are expressly contemplated for use herein.

The hydroxy-functional (meth)acrylic copolymers are typically produced by free radical solution co-polymerization wherein a solution of the monomers in a solvent, which is also capable of dissolving the copolymer, is created wherein the monomers are polymerized by a free radical polymerization, that is in the presence of the free radical initiator. Broadly, the aforementioned monomers are typically charged into a reflux reactor in the presence of at least one organic solvent and the free radical initiator. The concentration of the monomers in the solution may vary but it will be typical for the ratio by weight of monomer to solvent to be from 1:20 to 2:1, for example from 1:2 to 1.5:1. In various non-limiting embodiments, all values and ranges of values, both whole and fractional, including and between those set forth above are expressly contemplated for use herein.

Conventional polymerization conditions are typically utilized and include a temperature in the range of from 25 to 250° C., for example from 50 to 250° C. or from 75 to 250° C. The polymerization pressure is generally not critical and, as such, the polymerization may be conducted at sub-atmospheric, atmospheric or super-atmospheric pressure. The polymerization may be conducted, where necessary, under the exclusion of oxygen: the reaction vessel may be provided with an inert, dry gaseous blanket of, for example, nitrogen, helium and argon. In various non-limiting embodiments, all values and ranges of values, both whole and fractional, including and between those set forth above are expressly contemplated for use herein.

Conventionally, the at least one radical initiator is utilized in an amount of from 0.1 to 1 wt. %, for example from 0.1 to 0.5 wt. %, based on the total weight of the polymerizable monomers. In various non-limiting embodiments, all values and ranges of values, both whole and fractional, including and between those set forth above are expressly contemplated for use herein.

An exemplary class of free radical initiators suitable are organic peroxides, selected for example from: cyclic peroxides; diacyl peroxides; dialkyl peroxides; hydroperoxides; peroxycarbonates; peroxydicarbonates; peroxyesters; and, peroxyketals.

The free radical initiator may be known in the art. For example, the free radical initiator may include hydrogen peroxide. Alternatively, the free radical initiator may include an organic hydroperoxide. For completeness, included within the definition of hydroperoxides are materials such as organic peroxides or organic peresters which decompose or hydrolyze to form organic hydroperoxides in situ: examples of such peroxides and peresters are cyclohexyl and hydroxycyclohexyl peroxide and t-butyl perbenzoate, respectively.

In an embodiment of the disclosure, the free radical initiator comprises at least one hydroperoxide compound represented by the formula:

R^{p}OOH

wherein: R^{p} is an aliphatic or aromatic group containing up to 18 carbon atoms, and typically wherein: R^{p} is a C₁-C₁₂ alkyl, C₆-C₁₈ aryl or C₇-C₁₈ aralkyl.

The one or more free radical initiators can include: cumene hydroperoxide (CHP); para-menthane hydroperoxide; t-butyl hydroperoxide (TBH); t-butyl perbenzoate; t-butyl peroxy pivalate; di-t-butyl peroxide; t-butyl peroxy acetate; t-butyl peroxy-2-hexanoate; t-amyl hydroperoxide; 1,2,3,4-tetramethylbutyl hydroperoxide; benzoyl peroxide; dibenzoyl peroxide; 1,3-bis(t-butylperoxyisopropyl) benzene; diacetyl peroxide; butyl 4,4-bis (t-butylperoxy) valerate; p-chlorobenzoyl peroxide; t-butyl cumyl peroxide; di-t-butyl peroxide; dicumyl peroxide; 2,5-dimethyl-2,5-di-t-butylperoxyhexane; 2,5-dimethyl-2,5-di-t-butyl-peroxyhex-3-yne; and, 4-methyl-2,2-di-t-butylperoxypentane.

Azo polymerization initiators can also be used and may be chosen from: azo nitriles; azo esters; azo amides; azo amidines; azo imidazoline; macro azo initiators; and combinations thereof.

Examples of suitable azo polymerization initiators include: 2,2′-azobis (2-methylbutyronitrile); 2,2′-azobis(isobutyronitrile); 2,2′-azobis(2,4-dimethylvaleronitrile); 2,2′-azobis(4-methoxy-2,4-dimethylvaleronitrile); 1,1′-azobis(cyclohexane-1-carbonitrile); 4,4′-azobis(4-cyanovaleric acid); dimethyl 2,2′-azobis(2-methylpropionate); 2,2′-azobis[2-methyl-N-(2-hydroxyethyl)propionamide]; 2,2′-azobis (N-butyl-2-methylpropionamide); 2,2′-azobis[2-(2-imidazolin-2-yl)propane]dihydrochloride; 2,2′-azobis[2-(2-imidazolin-2-yl)propane]; 2,2′-azobis(2-methylpropionamidine)dihydrochloride; 2,2′-azobis[N-(2-carboxyethyl)-2-methylpropionamidine]tetrahydrate; 4,4-azobis(4-cyanovaleric acid), polymer with alpha, omega-bis(3-aminopropyl)polydimethylsiloxane (VPS-1001, available from Wako Pure Chemical Industries, Ltd.); and, 4,4′-azobis(4-cyanopentanoicacic)-polyethyleneglycol polymer (VPE-0201, available from Wako Pure Chemical Industries, Ltd.).

Redox initiators can also be used and include a combination of an oxidizing agent and a reducing agent. Suitable oxidizing agents may be chosen from cyclic peroxides, diacyl peroxides, dialkyl peroxides, hydroperoxides, peroxycarbonates, peroxydicarbonates, peroxyesters, peroxyketals and mixtures thereof. The corresponding reducing agent may be chosen from: alkali metal sulfites; alkali metal hydrogensulfites; alkali metal metabisulfites; formaldehyde sulfoxylates; alkali metal salts of aliphatic sulfinic acids; alkali metal hydrogensulfides; salts of polyvalent metals, in particular Co(II) salts and Fe(II) salts such iron(II) sulfate, iron(II) ammonium sulfate or iron(II) phosphate; dihydroxymaleic acid; benzoin; ascorbic acid; reducing saccharides, such as sorbose, glucose, fructose and/or dihydroxyacetone; and, mixtures thereof.

The free radical polymerization may be conducted in the presence of chain transfer agents which act to transfer free radicals and which reduce the molecular weight of the obtained polymer and/or control chain growth in the polymerization. When added, the chain transfer agent can constitute from 0.01 to 1 wt. % of the mixture, based on the total weight of polymerizable monomers. The amount of polymerization initiator and any chain transfer agents present will contribute to the number average molecular weight of the (co)polymer, although the choice of solvent may also be involved. In various non-limiting embodiments, all values and ranges of values, both whole and fractional, including and between those set forth above are expressly contemplated for use herein.

The free-radical polymerization reactions is typically performed in an organic solvent, typically a polar solvent. Effectual polar solvents can have a boiling point of at least 20° C., for instance at least 30° C. or at least 40° C., as measured at 1 atmosphere pressure (1.01325 Bar). Examples of such polar solvents, which may be used alone or in combination, include: C₁-C₈ alkanols, such as methanol, ethanol, n-propanol, isopropanol, n-butanol, sec-butanol and isobutanol; acetonitrile; N,N-di(C₁-C₄)alkylacylamides, such as N,N-dimethylformamide (DMF) and N,N-dimethylacetamide (DMAc); hexamethylphosphoramide; N-methylpyrrolidone; pyridine; esters, such as (C₁-C₅)alkyl acetates, ethoxydiglycol acetate, dimethyl glutarate, dimethyl maleate, dipropyl oxalate, ethyl lactate, benzyl benzoate, butyloctyl benzoate, and, ethylhexyl benzoate; ketones, such as acetone, ethyl ketone, methyl ethyl ketone (2-butanone) and methyl isobutyl ketone; ethers, such as tetrahydrofuran (THF), 2-methyltetrahydrofuran (2-MeTHF) and 1,2-dimethoxyethane; 1,3-dioxolane; dimethylsulfoxide (DMSO); and, dichloromethane (DCM). In an exemplary embodiment, the polymerization reaction is performed in the presence of a (C₁-C₅)alkyl acetate, such as ethyl acetate.

The hydroxyl-functional (meth)acrylate copolymer (a1) may be prepared from the monomer mixture by a skew feed polymerization process with at least two monomer feed streams. In an embodiment, the first feed stream comprises: I) from 60 to 100% by weight of the hydroxyl functional adduct of the monoepoxyester and the unsaturated carboxylic acid i), based on the total amount of component i) in the monomer mixture; II) from 0 to 60% by weight of the hydroxyl functional unsaturated monomer ii), based on the total amount of monomer ii) in the monomer mixture; III) from 0 to 30% by weight of the unsaturated acid functional monomer iii) based on the total amount of monomer iii) in the monomer mixture; and, IV) from 0 to 80% by weight of the at least one (meth)acrylate monomer represented by Formula MA, based on the total amount of monomers iv) in the monomer mixture; V) from 0 to 100% by weight the at least one vinyl aromatic monomer, based on a total amount of monomers v) in the monomer mixture; and, VI) from 0 to 100% by weight of the other polymerizable unsaturated monomers vi) based on the total amount of monomers vi) in the monomer mixture. The remaining feed stream or feed streams comprise the balance of the monomeric components i) to vi). In various non-limiting embodiments, all values and ranges of values, both whole and fractional, including and between those set forth above are expressly contemplated for use herein.

In such a skew feed polymerization, the total amount of free radical initiator to be added may be charged in full at the commencement of the first feeding step. It is however typical that fractions of the free radical initiator are charged over time and more particularly that a fraction is charged within each feed stream. Each initiator fraction which is dedicated to a particular feed stream to the reflux reactor may either be introduced as a single dose, introduced step wise or introduced continuously.

Analogously, the total amount of organic solvent can be charged in full at the commencement of the first feeding step. It is however typical that fractions of the organic solvent are charged over time and more particularly that a fraction is charged within each feed stream. Conventionally, a solvent fraction dedicated to a particular feed stream can be added to the reflux reactor prior to or simultaneously with the commencement of monomer addition.

In certain embodiments of the skew feed polymerization, the reactor contents may be rinsed with organic solvent after the addition of the first feed stream. An intermediate rinsing step may similarly be performed between each subsequent feed step.

The progress of the polymerization reaction and, where applicable, each feed step thereof can be monitored by potentiometric titration to determine the hydroxyl number and/or acid number. When these numbers reach a predetermined value based on a desired level of conversion, the reactor contents are typically cooled and then partially or wholly neutralized by the addition of the appropriate amount of base. The reactor contents comprising the hydroxyl-functional (meth)acrylate copolymer polymer (a1) may then be converted into an aqueous dispersion by normal or inverse dilution with water.

### Constituent (a2)

The binder part a) of the two-part (2k) composition of the present disclosure comprises (a2) at least one non-aromatic polyester having active hydrogen groups, wherein the non-aromatic polyester has: a number average molecular weight (Mn) of from about 500 to about 5000 Daltons; an acid value from about 0 to about 30 mg KOH/g; a calculated hydroxyl value of from about 100 to about 600 mg KOH/g; and, a calculated hydroxyl functionality of from about 2 to about 8. In various non-limiting embodiments, all values and ranges of values, both whole and fractional, including and between those set forth above are expressly contemplated for use herein.

In important embodiments, the non-aromatic polyester (a2) has: a number average molecular weight (Mn) of from about 500 to about 1500 Daltons; an acid value from about 0 to about 30 mg KOH/g; a calculated hydroxyl value of from about 250 to about 400 mg KOH/g; and, a calculated hydroxyl functionality of from about 4 to about 8. In various non-limiting embodiments, all values and ranges of values, both whole and fractional, including and between those set forth above are expressly contemplated for use herein.

It is typical that the ratio by weight of solids of constituent (a1) the hydroxyl-functional (meth)acrylate copolymer(s) to solids of constituent (a2) the polyester(s) is from about 100:1 to about 100:35, such as from about 100:5 to about 100:25, from about 100:5 to about 100:20 or from about 100:5 to about 100:15. In various non-limiting embodiments, all values and ranges of values, both whole and fractional, including and between those set forth above are expressly contemplated for use herein.

It is typical for the non-aromatic polyester to be prepared by polycondensation of: at least one hydroxyl functional component (a2h); at least one carboxyl functional component (a2c); and, optionally, at least one hydroxycarboxylic acid component (a2hc). These components can be selected according to type and quantity such that the above-mentioned molecular weight, acid value, hydroxyl value and functionality are obtained for the non-aromatic polyester. In general, the polycondensation reaction can be exemplified by a stoichiometric excess of hydroxyl groups to carboxyl groups. Typically the stoichiometric excess of hydroxyl groups to carboxyl groups may be from 5 to 40 mol. %, such as from 5 to 35 mol. %, from 5 to 30 mol. % or from 5 to 25 mol. %. In various non-limiting embodiments, all values and ranges of values, both whole and fractional, including and between those set forth above are expressly contemplated for use herein.

The hydroxyl functional component (a2h) may comprise, based on the weight of the hydroxyl functional component: from 75 to 100 wt. %, such as from 80 to 100 wt. % or from 90 to 100 wt. % of at least one polyol having from 3 to 6 hydroxyl groups; and, from 0 to 25 wt. %, such as from 0 to 20 wt. % or from 0 to 10 wt. % of at least one diol. In certain embodiments, the hydroxyl functional component (a2h) may comprise, based on the weight of the hydroxyl functional component: from 95 to 100 wt. % of at least one polyol having from 3 to 6 hydroxyl groups; and, from 0 to 5 wt. % of at least one diol. The hydroxyl functional component (a2h) in other embodiments consist essentially or consist of the at least polyol having from 3 to 6 hydroxyl groups. In various non-limiting embodiments, all values and ranges of values, both whole and fractional, including and between those set forth above are expressly contemplated for use herein.

Suitable polyols having from 3 to 6 hydroxyl groups may be saturated or unsaturated and may be aliphatic or cycloaliphatic compounds: the compounds can typically have a molecular weight of 400 Daltons or less. Non-limiting examples of aliphatic triols include: 1,2,3-propanetriol; 1,2,4-butanetriol; 2-ethyl-2-hydroxymethyl-1,3-propanediol (trimethylolpropane); 3-methyl-1,3,5-pentanetriol; 1,2,3-hexanetriol; 1,2,6-hexanetriol; 2,5-dimethyl-1,2,6-hexanetriol; 1,2,3-heptanetriol; 1,2,3-octanetriol; and, 2-hydroxymethyl-1,3-propanediol. Non-limiting examples of aliphatic tetrols and aliphatic pentols include: 2,2-bis(hydroxymethyl)propane-1,3-diol (pentaerythritol); pentose; pentopyranose; 6-deoxyhexopyranose; 2,5-anhydrohexitol; 1,5-anhydrohexitol; 6-deoxyhexose; 1-deoxyhexitol; and, pentitol. An exemplary polyol having six hydroxyl groups is D-glucitol (sorbitol). In embodiments, 2-ethyl-2-hydroxymethyl-1,3-propanediol (trimethylolpropane), 2,2-bis(hydroxymethyl)propane-1,3-diol (pentaerythritol) or mixtures thereof may be used.

The present disclosure does not preclude the use—as a reactant polyol having from 3 to 6 hydroxyl groups—of (C₂-C₄)alkylene oxide adducts of the aforementioned diols, triols and higher polyols.

Suitable diols for use in the hydroxyl functional component may be saturated or unsaturated and may be aliphatic or cycloaliphatic dihydroxy compounds. The reactant diols may typically have a molecular weight of 250 Daltons or less. When used herein, the term “diol” can include equivalent ester forming derivatives thereof, provided, however, that the molecular weight requirement pertains to the diol only and not to its derivative. Exemplary ester forming derivatives include the acetates of the diols as well as, for example, ethylene oxide or ethylene carbonate for ethylene glycol.

Typical diols are those having from 2 to 10 carbon atoms. Examples of these diols include: ethylene glycol; propylene glycol; 1,3-propane diol; 1,2-butane diol; 2-methyl propanediol; 1,3-butane diol; 1,4-butane diol; 2,3-butanediol; neopentyl glycol; hexanediol; decanediol; hexamethylene glycol; cyclohexane dimethanol; and, polyoxalkylene glycols, such as diethylene glycol, dipropylene glycol, triethylene glycol, tetraethylene glycol, tripropylene glycol and tetrapropylene glycol. Mixtures of such diols may be employed.

The carboxyl functional component (a2c) can comprise, based on the weight of the carboxyl functional component: from 75 to 100 wt. %, such as from 80 to 100 wt. % or from 90 to 100 wt. % of at least one dicarboxylic acid; and, from 0 to 25 wt. %, such as from 0 to 20 wt. % or from 0 to 10 wt. % of at least one monocarboxylic acid. In various non-limiting embodiments, all values and ranges of values, both whole and fractional, including and between those set forth above are expressly contemplated for use herein.

Dicarboxylic acids which are suitable for use herein include aliphatic and/or cycloaliphatic dicarboxylic acids. The dicarboxylic acids can typically have a molecular weight of less than 600 Daltons. The term “dicarboxylic acids” as used herein includes equivalents of dicarboxylic acids having two functional carboxyl groups which perform substantially like dicarboxylic acids in reaction with polyols in forming polyesters. These equivalents include esters and ester forming reactive derivatives, such as acid halides and anhydrides, provided however that the molecular weight range mentioned above pertains to the acid and not to its equivalent ester or ester-forming derivatives. Thus, an ester of a dicarboxylic acid having a molecular weight greater than 300 Daltons or an acid equivalent of a dicarboxylic acid having a molecular weight greater than 300 Daltons are included provided the acid has a molecular weight below 300 Daltons. Additionally, the dicarboxylic acids may contain any substituent groups(s) or combinations which do not substantially interfere with the polymer formation and use of the polymer of this disclosure.

Typical dicarboxylic acids include those chosen from: hexahydrophthalic acid; 1,4-cyclohexane dicarboxylic acid; and, alkyl dicarboxylic acids having a total of 2 to 16 carbons atoms. Representative alkyl dicarboxylic acids include: glutaric acid; adipic acid; pimelic acid; succinic acid; sebacic acid; azelaic acid; and, malonic acid. Adipic acid may be used, for example.

Dimer fatty acids may be used as dicarboxylic acid reactants for the above described polyester synthesis reaction. Exemplary dimer fatty acids include C₃₆ to C₄₄ aliphatic diacids which may be prepared by the oxidative coupling of C₁₈ to C₂₂ unsaturated monoacids. Dimer acids obtained from the oxidative coupling of oleic acid, linoleic acid or talloil fatty acid may be used. However, in those embodiments in which at least one dimer fatty acid is employed in the reaction, it is typical that at least one non-dimerized dicarboxylic acid is present. More particularly, where at least one dimer fatty acid is employed, the dimer fatty acid can be reacted in an amount of from 5 to 50 wt. %, typically from 5 to 40 wt. %, from 5 to 30 wt. % or from 5 to 25 wt. %, based on the total weight of the carboxyl functional component. In various non-limiting embodiments, all values and ranges of values, both whole and fractional, including and between those set forth above are expressly contemplated for use herein.

Monocarboxylic acids which are suitable reactants in the polycondensation reaction include aliphatic and/or cycloaliphatic monocarboxylic acids. These monocarboxylic acids may typically have molecular weight of less than 300 Daltons. Exemplary monocarboxylic acids which may be used alone or in combination include: formic acid; acetic acid; propionic acid; n-butanoic acid; isobutanoic acid; 2-ethylhexanoic acid; octanoic acid; isononanoic acid; decanoic acid, dodecanoic acid; tetradecanoic acid; palmitic acid; and, stearic acid.

A (cyclo)aliphatic hydroxycarboxylic acid component (a2hc) may optionally participate in the polycondensation reaction which yields the non-aromatic polyester polyol (a2). When present, it is typical that the total amount of hydroxycarboxylic acid is at most 10 wt. %, based on the total weight of reactant compounds (a2h, a2c and a2hc). Exemplary hydroxycarboxylic acids include: 12-hydroxystearic acid; 6-hydroxyhexanoic acid; citric acid; tartaric acid; and, dimethylolpropionic acid. The corresponding lactones may also be employed as a reactant instead of the monohydroxycarboxylic acids.

It is typical herein for the reaction mixture provided to the aforementioned polycondensation reaction to be essentially free of solvent. Moreover, the initial reaction mixture can be essentially free of added water. However, if the reaction is performed in solution, suitable solvents can be non-reactive, essentially anhydrous, organic liquids capable of dissolving at least 1 wt. % and typically over 10 wt. % of the polyester products at 25° C. Suitable organic solvents, which may be used alone or in combination, include: aromatic hydrocarbons, such as toluene and xylene; aliphatic hydrocarbons, such as heptane and decane; alicyclic hydrocarbons, such as cyclohexane and Decalin; chlorinated hydrocarbons such as chloroform and trichloroethylene; esters, such as ethyl acetate and methyl butyrate; and, ethers, such as tetrahydrofuran (THF) and dioxane.

The polycondensation reaction may be conducted in the presence of an appropriate catalyst. Common catalysts include acid catalysts and organometallic catalysts, with titanium, zirconium and tin alkoxides, carboxylates and chelates being examples of the latter. Typically, the catalyst is a titanium alkoxide, titanium carboxylate, or titanium chelate catalyst.

Exemplary titanium alkoxides include: tetramethyl titanates; tetraethyl titanates; tetrapropyl titanates; tetra-isopropyl titanates; tetrabutyl titanates; tetrapentyl titanates; tetrahexyl titanates; tetra-octyl titanates; tetranonyl titanates; tetradodecyl titanates; tetrahexadecyl titanates; tetra-octadecyl titanates; tetradecyl titanates; tetraheptyl titanates; and, mixtures thereof. The tin or zirconium counterparts of the above alcoholates can be substituted in part as catalysts.

It is typical that the catalyst be used in an amount of from 0.1 to 5 wt. %, for instance from 0.1 to 2.0 wt. %, from 0.1 to 1.5 wt. % or from 0.1 to 1.0 wt. %, based on the total weight of the reactants (a2h, a2c and a2hc). In various non-limiting embodiments, all values and ranges of values, both whole and fractional, including and between those set forth above are expressly contemplated for use herein.

The polycondensation reaction may also be carried out in the presence of at least one stabilizer. Typical stabilizers—which would conventionally be present in an amount of from 0.01 to 5 wt. %, based on the total weight of the reactants (a2h, a2c and a2hc)—may be: hydroquinone and its alkylated derivatives; phenolic compounds with electron-withdrawing substituents; and, quinoid compounds. Specific examples of such stabilizing compounds, which can be employed alone or in combination, include: 2,3-dichloro-1,4-naphthoquinone; 2,3-dibromo-1,4-naphthoquinone; 2,3-dicyano-1,4-naphthoquinone; 2-chloro-1,4-naphthoquinone; 2-bromo-1,4-naphthoquinone; 2-nitro-1,4-naphthoquinone; 2,3,6,7,8,9-hexachloro-1,4-naphthoquinone; 3-bromo-2-chloro-1,4-naphthoquinone; 1,4-hydroquinone; 4-tertiary-butylcatechol; 4-methoxyphenol; methylhydroquinone; 4-chloro-2-nitrophenol; 2,4-dinitropara-cresol; 2,4-dinitrophenol; and, phenothiazine.

Where a stabilizer is employed in the polycondensation reaction, one or more known electron donors which form electron-donor-acceptor complexes may further be added to the mixture of reactants. Such electron donors—which would conventionally constitute in toto from 0.01 to 1 wt. %, based on the total weight of the reactants (a2h, a2c and a2hc)—include: 1-methylimidazole; 2-methylimidazole; 2-ethyl-4-methylimidazole; 2-heptadecylimidazole; 2-isopropylimidazole; 2-(2-ethyl-4-methylimidazyl)-1-cyanoethane; and, 2-undecylimidazole. In various non-limiting embodiments, all values and ranges of values, both whole and fractional, including and between those set forth above are expressly contemplated for use herein.

In synthesizing the polyesters, the reactant species, catalyst(s) and any stabilizer and electron donor employed, are typically charged to a suitable reaction vessel equipped with a distillation apparatus. That vessel may typically have been dried and purged with an inert gas—such as nitrogen or argon—prior to its charging and that inert atmosphere may be maintained in the vessel during the reaction. The temperature of the vessel is typically set based on lowest boiling point of the reactants, which is conventionally an alcohol. In various embodiments, a temperature of from about 125 to about 300° C. or from about 125 to about 275° C. may be considered standard. For an initial duration, the vessel may be maintained at atmospheric pressure but, once no more water distillation is observed, at least a partial vacuum can be applied to the vessel to drive the polycondensation reaction to completion.

The reaction may be monitored by analyzing the acid value (Av) of the reactant mixture over time and the reaction typically stopped when that determined acid value is at a value of less than about 10 mg KOH/g or ideally less than about 5 mg KOH/g or even less than about 1 mg KOH/g. The time to reach this point will be dependent on various factors, such as temperature, catalyst type and the reactants used: it will generally, however, be from about 0.5 to about 20 hours, for instance from about 1 to about 8 hours or from about 2 to about 6 hours. In various non-limiting embodiments, all values and ranges of values, both whole and fractional, including and between those set forth above are expressly contemplated for use herein.

The polyester synthesized by the polycondensation reaction may be separated and purified using methods known in the art, including filtration, extraction, evaporation, distillation or chromatography.

### (a3) Further (Meth)Acrylate Co-Polymer

The binder part a) of the composition may, in certain embodiments, further comprise: (a3) at least one (meth)acrylate copolymer having active hydrogen groups which is distinct from the hydroxyl-functional (meth)acrylate polymer(s) of constituent (a1), wherein the (meth)acrylate copolymer (a3) has a water solubility at about 20° C. of less than about 6 g/100 ml of water.

This supplementary or co-binder (meth)acrylate constituent (a3) would typically be a minority constituent of binder part a). For example, the (meth)acrylate copolymer (a3) may, in certain embodiments, be present in binder part a) in an amount of from 0 to 20 wt. %, based on the weight of said binder part a). In certain embodiments, the (meth)acrylate copolymer (a3) may be present in part a) in a fractional amount with respect to the constituent (at) thereof, such as an amount of from 0 to 20 wt. %, from 0 to 10 wt. % or from 1 to 5 wt. %, based on the weight of constituent (a1). In various non-limiting embodiments, all values and ranges of values, both whole and fractional, including and between those set forth above are expressly contemplated for use herein.

In addition to its being water-insoluble, the (meth)acrylate copolymer of constituent (a3) may not be water-dispersible. For example, the copolymer typically does not form a stable dispersion in water such that the dispersion would show settlement or phase separation when stored for 4 weeks at 40° C. The inclusion of such a copolymer tends to increase the hydrophobicity of the water-borne coating composition, which can serve to improve the applicability thereof and the etch and weathering resistance of the coatings obtained therefrom.

In certain embodiments, the (meth)acrylate polymer of constituent (a3) has: a calculated hydroxyl value of from about 100 to about 600 mg KOH/g; an acid value of from about 0 to about 35 mg KOH/g; and, a number average molecular weight of from about 1000 to about 4000 Daltons. In other embodiments, the (meth)acrylate polymer of constituent (a3) has: a calculated hydroxyl value of from about 100 to about 300 mg KOH/g, such as from about 100 to 200 mg KOH/g; an acid value of from about 0 to about 30 mg KOH/g, such as from 10 to 30 mg KOH/g; and, a number average molecular weight of from about 1000 to about 4000 Daltons. Within the binder part a), the co-binder constituent (a3) may be further exemplified by having a particle size of from about 60 to about 200 nm, as determined by laser diffraction. In various non-limiting embodiments, all values and ranges of values, both whole and fractional, including and between those set forth above are expressly contemplated for use herein.

The hydroxy-functional (meth)acrylic copolymer(s) (a3) may be obtained commercially or may be produced as described herein above. The ethylenically unsaturated monomers of that co-polymerization can be selected according to type and quantity such that the desired molecular weight, acid value and hydroxyl value are obtained for the co-polymer. The synthesis of (meth)acrylic copolymer B of the examples of US2012237688A1 (Huybrechts et al.) may be utilized herein, wherein this reference is expressly incorporated by reference in its entirety in various non-limiting embodiments.

(a4), (a5) Non-Polymeric Polyol

The addition of particular non-polymeric, low-molecular weight polyol(s) to part a) of the composition can improve the humidity resistance of the coatings obtained from the compositions, as well as promoting more facile mixing between the two parts of the composition. Any improvement in such mixing may be translated to better applicability of the coating compositions and to an improved appearance of the coatings obtained therefrom.

In an embodiment, the binder part a) of the two-part (2K) composition may further comprise: (a4) at least one non-polymeric, acyclic polyol having a weight average molecular weight (Mw) of less than about 300 Daltons and a water solubility at about 20° C. of less than about 6 g/100 ml of water. For example, the (a4) at least one non-polymeric, acyclic polyol may be present in binder part a) in an amount of from 0 to 10 wt. %, based on the weight of said binder part a). In certain embodiments, the (a4) at least one non-polymeric, acyclic polyol may be present in binder part a) in a fractional amount with respect to the constituent (a1) thereof. For instance, binder part a) may comprise from 0 to 10 wt. %, from 0 to 8 wt. %, from 0 to 5 wt. % or from 0 to 3 wt. % of (a4) the at least one non-polymeric acyclic polyol, based on the weight of constituent (a1). In various non-limiting embodiments, all values and ranges of values, both whole and fractional, including and between those set forth above are expressly contemplated for use herein.

Exemplary non-polymeric, acyclic polyols which may be used alone or in combination include: 2-ethylhexane-1,3-diol; and, 2-butyl-2-ethyl-1,3-propanediol.

In another embodiment, which is not mutually exclusive of that given above, the binder part a) of the two-part (2K) composition may further comprise: (a5) at least one non-polymeric, cycloaliphatic polyol having a weight average molecular weight (Mw) of less than about 300 Daltons. For example, the (a5) at least one non-polymeric, cycloaliphatic polyol may be present in binder part a) in an amount of from 0 to 10 wt. %, based on the weight of said binder part a). In certain embodiments, the (a5) at least one non-polymeric, cycloaliphatic polyol may be present in binder part a) in a fractional amount with respect to the constituent (a1) thereof. For instance, binder part a) may comprise from 0 to 10 wt. %, from 0 to 8 wt. %, from 0 to 5 wt. % or from 0 to 3 wt. % of (a5) at least one non-polymeric, cycloaliphatic polyol, based on the weight of constituent (a1). In various non-limiting embodiments, all values and ranges of values, both whole and fractional, including and between those set forth above are expressly contemplated for use herein.

Exemplary non-polymeric, cycloaliphatic polyols which may be used alone or in combination include: 1,4-cyclohexanedimethanol; 1,3-cyclohexanedimethanol; 1,2-cyclohexanedimethanol; 1,4-cyclohexanediethanol; 2,2-bis(4-hydroxycyclohexyl)propane; dianhydro-D-glucitol (isosorbide); and, 4,8-bis(hydroxymethyl)tricyclo[5.2.1.0^{2,6}]decane. In an embodiment, the at least one non-polymeric, cycloaliphatic polyol comprises 1,4-cyclohexanedimethanol.

### Part b) Crosslinker

The crosslinker part b) of the present composition comprises at least one polyisocyanate compound having pendant —NCO groups. It is not precluded that the crosslinker part b) of the composition may comprise further crosslinking compounds in addition to the polyisocyanate compound(s) having pendant —NCO groups, such as melamine resins and blocked isocyanates.

The molar ratio of active hydrogen atoms to —NCO groups in the two part (2K) composition is from about 5:1 to about 1:5, typically from about 3:1 to about 1:3. The molar ratio of active hydrogen atoms to —NCO groups may, for example, be from about 2:1 to about 1:2 or from about 1.5:1 to about 1:1.5. The term “—NCO groups” includes blocked —NCO groups which are therefore included in the molar ratio term. In various non-limiting embodiments, all values and ranges of values, both whole and fractional, including and between those set forth above are expressly contemplated for use herein.

As used herein “polyisocyanate” means a compound comprising at least two —N═C═O functional groups, for example from 2 to 5 or from 2 to 4 —N═C═O functional groups. Suitable polyisocyanates include aliphatic, cycloaliphatic, aromatic and heterocyclic isocyanates, dimers and trimers thereof, and mixtures thereof.

Aliphatic and cycloaliphatic polyisocyanates can comprise from 6 to 100 carbon atoms linked in a straight chain or cyclized and having at least two isocyanate reactive groups. Examples of suitable aliphatic isocyanates include straight chain isocyanates such as ethylene diisocyanate, trimethylene diisocyanate, tetramethylene diisocyanate, 1,6-hexamethylene diisocyanate (HDI), octamethylene diisocyanate, nonamethylene diisocyanate, decamethylene diisocyanate, triisocyanatenonane, 1,6,11-undecanetriisocyanate, 1,3,6-hexamethylene triisocyanate, bis(isocyanatoethyl)-carbonate, and bis(isocyanatoethyl) ether. Exemplary cycloaliphatic polyisocyanates include dicyclohexylmethane 4,4′-diisocyanate (H₁₂MDI), 1-isocyanatomethyl-3-isocyanato-1,5,5-trimethyl-cyclohexane (isophorone diisocyanate, IPDI), cyclohexane 1,4-diisocyanate, hydrogenated xylylene diisocyanate (H₆XDI), 1-methyl-2,4-diisocyanato-cyclohexane, m- or p-tetramethylxylene diisocyanate (m-TMXDI, p-TMXDI) and dimer fatty acid diisocyanate. In various non-limiting embodiments, all values and ranges of values, both whole and fractional, including and between those set forth above are expressly contemplated for use herein.

The term “aromatic polyisocyanate” is used herein to describe organic isocyanates in which the isocyanate groups are directly attached to the ring(s) of a mono- or polynuclear aromatic hydrocarbon group. In turn the mono- or polynuclear aromatic hydrocarbon group means an essentially planar cyclic hydrocarbon moiety of conjugated double bonds, which may be a single ring or may include multiple condensed (fused) or covalently linked rings. The term aromatic also includes alkylaryl. Typically, the hydrocarbon (main) chain includes 5, 6, 7 or 8 main chain atoms in one cycle. Examples of such planar cyclic hydrocarbon moieties include cyclopentadienyl, phenyl, napthalenyl-, [10]annulenyl-(1,3,5,7,9-cyclodecapentaenyl-), [12]annulenyl-, [8]annulenyl-, phenalene (perinaphthene), 1,9-dihydropyrene, chrysene (1,2-benzophenanthrene). Examples of alkylaryl moieties are benzyl, phenethyl, 1-phenylpropyl, 2-phenylpropyl, 3-phenylpropyl, 1-naphthylpropyl, 2-naphthylpropyl, 3-naphthylpropyl and 3-naphthylbutyl.

Exemplary aromatic polyisocyanates include: all isomers of toluene diisocyanate (TDI), either in the isomerically pure form or as a mixture of several isomers; naphthalene 1,5-diisocyanate; diphenylmethane 4,4′-diisocyanate (MDI); diphenylmethane 2,4′-diisocyanate and mixtures of diphenylmethane 4,4′-diisocyanate with the 2,4′ isomer or mixtures thereof with oligomers of higher functionality (so-called crude MDI); xylylene diisocyanate (XDI); diphenyl-dimethylmethane 4,4′-diisocyanate; di- and tetraalkyl-diphenylmethane diisocyanates; dibenzyl 4,4′-diisocyanate; phenylene 1,3-diisocyanate; phenylene 1,4-diisocyanate; triphenylmethane triisocyanate, 1,3,5-benzene triisocyanate; and, 2,4,6-toluene triisocyanate.

The polyisocyanates, where used, may have been biuretized, allophanated and/or isocyanurated by generally known methods. In use, such derivatives may be substantially free of the parent diisocyanate: the derivatives may have been separated from any excess parent diisocyanate by conventional means, including but not limited to distillation.

It is also noted that the term “polyisocyanate” includes hydrophilic pre-polymers formed by the partial reaction of the aforementioned aliphatic, cycloaliphatic, aromatic and heterocyclic isocyanates with polyether polyols or polyester polyols to give isocyanate functional oligomers, which oligomers may be used alone or in combination with free isocyanate(s).

The term ‘polyisocyanate’ still further includes ionically modified, isocyanate functional compounds, for example ionically modified isocyanate functional pre-polymers. The ionically modified polyisocyanates contain at least two isocyanate groups and at least one ionic or ionogenic group. In certain embodiments, anionically modified, isocyanate functional compounds, such as anionically modified, isocyanate functional pre-polymers may be included in the crosslinker part b). In this regard, suitable anionic or anionic groups include carboxylic acid groups, sulfonic acid groups, phosphonic acids groups and the salts thereof. Suitable bases which may neutralize the anionic, groups to form such salts include: alkali metals, such as Na and K; ammonium; a3d, trialkylamines, such as triethylamine and triisopropylamine.

Exemplary polyisocyanates which are commercially available from Covestro AG and which may be used in the present disclosure include: Desmodur N3900; Bayhydur® Ultra 2487/1; Bayhydur® Ultra 2700; Bayhydur® Ultra 3100; Bayhydur® Ultra 304; Bayhydur® Ultra 305; Bayhydur® Ultra 307; Bayhydur® XP 2451/1; Bayhydur® XP 2547; Bayhydur® WXP 2655; Bayhydur® XP 2759; Bayhydur® 2858 XP; Bayhydur® Eco 701-90; Bayhydur® 401-60 PGDA; and, Bayhydur® 401-70 MPA/X.

### Additives and Adjunct Ingredients

The compositions of the present disclosure can further comprise, or be free of, one or more adjuvants and additives that can impart improved properties to these compositions and the coatings obtained therefrom. For instance, the adjuvants and additives may impart one or more of: reduced dullness; improved distinctiveness of image (DOI); longer enabled processing time; faster curing time; lower residual tack; and, improved levelling. Included among such adjuvants and additives are: catalysts; plasticizers; stabilizers including UV stabilizers; reactive diluents; dessicants or moisture scavengers; adhesion promoters; wetting agents; defoamers; flame retardants; rheology control agents; color pigments; dyes; effect pigments; co-solvents; and, non-reactive diluents.

Such adjuvants and additives can be used in such combination and proportions as desired, provided they do not adversely affect the nature and essential properties of the composition. While exceptions may exist in some cases, these adjuvants and additives typically in toto comprise from 0 to 40 wt. %, for example from 0 to 30 wt. % of the total composition.

In general, adjunct materials and additives which contain reactive groups can be blended into the appropriate part of a two-part (2K) composition to ensure the storage stability thereof; unreactive materials may be formulated into either or both of the two parts. For example, the crosslinker part b) of the composition may be free of compounds comprising active hydrogen atoms in certain embodiments.

The compositions may comprise one or more catalysts for the reaction of —NCO groups with active hydrogen compounds. Standard catalysts known in the art include: stannous salts of carboxylic acids, such as stannous octoate, stannous oleate, stannous acetate and stannous laureate; dialkyltin dicarboxylates, such as dibutyltin dilaureate and dibutyltin diacetate; tertiary amines; alkanolamine compounds; 2,3-dimethyl-3,4,5,6-tetrahydropyrimidine; tetraalkylammonium hydroxides; alkali metal hydroxides; alkali metal alcoholates; tin alkoxides, such as dibutyltin dimethoxide, dibutyltin diphenoxide and dibutyltin diisoproxide; tin oxides, such as dibutyltin oxide and dioctyltin oxide; the reaction products of dibutyltin oxides and phthalic acid esters; tin mercaptides; alkyl titanates; organoaluminum compounds such as aluminum trisacetylacetonate, aluminum trisethylacetoacetate and diisopropoxyaluminum ethylacetoacetate; chelate compounds such as zirconium tetraacetylacetonate and titanium tetraacetylacetonate; organosilicon titanium compounds; bismuth tris-2-ethylhexanoate; acid compounds such as phosphoric acid and p-toluenesulfonic acid; triphenylborane; triphenylphosphine; 1,8-diazabicycloundec-7-ene (DBU); 1,5-diazabicyclo[4.3.0]non-5-ene; 1,4-diazabicyclo[2.2.2]octane; 4-dimethylaminopyridine; 1,5,7-triazabicyclo[4.4.0]dec-5-ene; 7-methyl-1,5,7-triazabicyclo[4.4.0]dec-5-ene; 1,8-bis(tetramethylguanidino)naphthalene; and, 2-tert-butyl-1,1,3,3-tetramethylguanidine.

Depending on the nature of the isocyanate, the amount of catalyst employed is typically from 0.005 to 2% by weight of the composition. For example, the composition may comprise, based on the weight of the composition, from 0.01 to 2 wt. % or from 0.01 to 1 wt. % of catalyst. In various non-limiting embodiments, all values and ranges of values, both whole and fractional, including and between those set forth above are expressly contemplated for use herein.

The addition of certain additives may promote the adhesion of the coating compositions to particular substrates. In this regard, the composition may comprise from 0 to 5 wt. %, for example from 0.5 to 5 wt. % based on the weight of the composition, of at least one additive chosen from: morin(2-(2,4-dihydroxy phenyl)-3,5,7-trihydroxy-4H-1-cumarone-4-ketone); 3,7-dihydroxy-2-naphthoic acid (3,7-dihydroxy naphthlene-2-carboxylic acid); pyrogallol carboxylic acid (2,3,4-trihydroxybenzoic acid); 3,4-dihydroxy-benzene guanidine-acetic acid; gallic acid (3,4,5-trihydroxybenzoic acid); para-aminosalicylic acid (4-amino-2-hydroxybenzoic acid, PAS); flutter acid (4,4′-methylene-bis(3-hydroxy-2-naphthoic acid)); citric acid (2-hydroxypropane-1,2,3-tricarboxylic acid); and, mixtures thereof. In certain embodiments, citric acid, gallic acid or para-aminosalicylic acid (PAS) may be used, alone or in combination.

The term “pigment” as used herein refers to a molecule which is insoluble in the liquid carrier and imparts either color or an optical effect thereto.

The composition may in certain embodiments comprise at least one colored pigment. Colored pigments having utility herein may be organic or inorganic. Exemplary colored pigments, which may be used alone or in combination include: azo pigments; anthraquinone pigments; benzimidazolone pigments; isoindoline pigments; napthol pigments, such as napthol reds; nitroso pigments; perinone pigments; perylene pigments; polycyclic pigments; pyrropyrrol pigments; pthalocyanines, such as copper pthalocyanine blue and copper pthalocyanine green; quinacridones such as quinacridone violets; quinophthalone pigments; dioxazine pigments; carbon black; anazurite; aluminum silicate; aluminum potassium silicate; antimony oxide; barium metaborate; barium sulfate; cadmium sulfide; cadmium selenide; calcium carbonate; calcium metaborate; calcium metasilicate; chromium oxides; clay; copper oxides; copper oxychloride; feldspar; iron oxides, such as yellow and red iron oxides; kaolinite; lithopone; magnesium silicates; nepheline syenite; silicates; sulfides; tale; titanium dioxide; ultramarine; zinc chromate; zinc oxide; and, zinc phosphate.

The composition may in certain embodiments comprise at least one effect pigment by which is meant a pigment that exhibits optical effects that are not caused by absorption. Particular examples include graphite effect pigments, metallic effect pigments and pearlescent pigments. The effect pigments may possess at least one of: a specific surface area of from about 1 to about 60 m²/g, for instance from about 5 to about 50 m²/g, as determined using nitrogen absorption in accordance with the Brunauer-Emmett-Teller (BET) method; and, a mean volume particle size (Dv50) of from about 1 to about 500 μm, for instance from about 5 to about 100 μm, as determined by laser diffraction. In various non-limiting embodiments, all values and ranges of values, both whole and fractional, including and between those set forth above are expressly contemplated for use herein.

The metallic effect pigments may include particles that are acicular, spherical, ellipsoidal, cylindrical, bead-like, cubic, platelet-like or flaky. Particles of different shapes may be used alone or in combination.

Exemplary metals, of which the metallic effect pigments may comprise, include: aluminum; copper; copper-zinc alloys; copper-tin alloys; stainless steel; carbon steel; iron; silver; zinc; nickel; titanium; chromium; manganese; vanadium; magnesium; and, zinc-magnesium alloys. The constituent metal may be coated with one or more inert oxides to form the effect pigment. Exemplary metal oxides include: silicon dioxide; titanium dioxide; zinc oxide; zirconium dioxide; tin oxide; cerium dioxide; vanadium oxide; manganese oxide; lead oxide; chromium oxide; iron oxide; aluminum oxide, and, tungsten oxide. When present in the pigment, the thicknesses of such metal oxide layers will typically be from 20 to 400 nm, such as from 50 to 400 nm or from 50 to 250 nm. In various non-limiting embodiments, all values and ranges of values, both whole and fractional, including and between those set forth above are expressly contemplated for use herein.

Pearlescent pigments include a transparent, non-metallic, platelet-shaped substrate that is coated with at least one layer comprising metal oxides having refractive indices. In some embodiments, multiple layers of metal oxides are used wherein there is a difference of at least about 0.1 in the refractive indices of the consecutive layers. In some embodiments, the pearlescent pigment has an interference color when viewed over a black background.

Exemplary non-metallic platelet substrates include: natural mica; synthetic mica; bismuth oxychloride; graphite; aluminum oxide; micaceous iron oxide; perlite; silicon dioxide; borosilicate glass; glass; titanium dioxide-coated mica; and, iron oxide-coated mica.

Exemplary metal oxides, from which the one or more coating layers of the pearlescent pigments may be formed, include: silicon dioxide; titanium dioxide; zinc oxide; zirconium dioxide; tin oxide; cerium dioxide; vanadium oxide; manganese oxide; lead oxide; chromium oxide; iron oxide; aluminum oxide; and, tungsten oxide. The thickness of each metal oxide layer of the pearlescent pigment may be independently determined but will conventionally be from about 20 to about 400 nm, such as from 50 to 400 nm or from 50 to 250 nm. In various non-limiting embodiments, all values and ranges of values, both whole and fractional, including and between those set forth above are expressly contemplated for use herein.

The rheology control agent which optionally has utility in the present composition may comprise fillers, thickeners and combinations thereof. The total amount of rheology control agent in the composition typically does not exceed 10 wt. %, based on the weight of the composition. The composition may comprise, for example, from 0 to 8 wt. %, from 0 to 5 wt. % or from 0 to 2 wt. % of rheology control agent, based on the weight of the composition. In various non-limiting embodiments, all values and ranges of values, both whole and fractional, including and between those set forth above are expressly contemplated for use herein.

Exemplary thickeners include: clay based thickeners, such as organoclays; polysaccharides, such as guar and xanthan; polyacrylates; and, associative thickeners. Mention may, in particular, be made of the use as a polysaccharide thickener of cellulose or cellulose derivatives, such as: carboxymethylcellulose; methylcellulose; hydroxyethylcellulose; hydroxyethylmethylcellulose; hydroxypropylmethylcellulose; cellulose nanofibers; and, cellulose nanocrystals.

The filler may include particles that are acicular, spherical, ellipsoidal, cylindrical, bead-like, cubic or platelet-like may be used alone or in combination. Moreover, it is envisaged that agglomerates of more than one particle type may be used. The fillers typically have a mean volume particle size (Dv50), as measured by laser diffraction, of from about 0.1 to about 1500 Wm, for example from about 1 to about 1250 Wm. In various non-limiting embodiments, all values and ranges of values, both whole and fractional, including and between those set forth above are expressly contemplated for use herein.

Exemplary fillers include calcium carbonate, calcium oxide, calcium hydroxide (lime powder), precipitated and/or pyrogenic silica, zeolites, bentonites, wollastonite, magnesium carbonate, diatomite, barium sulfate, alumina, clay, tale, titanium oxide, iron oxide, zinc oxide, sand, quartz, flint, mica, glass beads, glass powder, and other ground mineral substances. Organic fillers can also be used, in particular wood fibers, wood flour, sawdust, cellulose, cotton, pulp, cotton, wood chips, chopped straw, chaff, ground walnut shells, and other chopped fibers. Short fibers such as glass fibers, glass filament, polyacrylonitrile, carbon fibers, Kevlar fibers, or polyethylene fibers can also be added.

When present, pyrogenic and/or precipitated silica can have a BET specific surface area of from about 10 to about 90 m²/g. When they are used, such silica(s) may not cause any additional increase in the viscosity of the composition but can contribute to strengthening of the cured composition. In various non-limiting embodiments, all values and ranges of values, both whole and fractional, including and between those set forth above are expressly contemplated for use herein.

It is likewise conceivable to use pyrogenic and/or precipitated silica having a higher BET specific surface area, advantageously from about 100 to about 250 m²/g as a filler: because of the greater BET surface area, the effect of strengthening the cured composition is achieved with a smaller proportion by weight of silica. In various non-limiting embodiments, all values and ranges of values, both whole and fractional, including and between those set forth above are expressly contemplated for use herein.

Hollow spheres having a mineral shell or a plastic shell can also be used. These can be, for example, hollow glass spheres that are obtainable commercially under the trade names Glass Bubbles®. Plastic-based hollow spheres, such as Expancel® or Dualite®, may be used. For example, they can include inorganic or organic substances and each have a mean volume particle size (Dv50) of 1 mm or less, typically 500 μm or less as determined by laser diffraction.

Fillers which impart thixotropy to the composition may be typical for many applications. Such fillers are also described as rheological adjuvants and include, for example, hydrogenated castor oil, fatty acid amides and swellable plastics, such as PVC.

A “plasticizer” for the purposes of this disclosure is a substance that decreases the viscosity of the composition and thus facilitates its processability. Herein the plasticizer may constitute up to 10 wt. % or up to 5 wt. %, based on the total weight of the composition, and is typically chosen from: diurethanes; ethers of monofunctional, linear or branched C4-C16 alcohols, such as Cetiol OE (obtainable from BASF); esters of abietic acid, butyric acid, thiobutyric acid, acetic acid, propionic acid esters and citric acid; esters based on nitrocellulose and polyvinyl acetate; fatty acid esters; dicarboxylic acid esters; esters of OH-group-carrying or epoxidized fatty acids; glycolic acid esters; benzoic acid esters; phosphoric acid esters; sulfonic acid esters; trimellitic acid esters; polyether plasticizers, such as end-capped polyethylene or polypropylene glycols; polystyrene; hydrocarbon plasticizers; chlorinated paraffin; and, mixtures thereof. It is noted that, in principle, phthalic acid esters can be used as the plasticizer but these are not typical due to their toxicological potential.

“Stabilizers” for the purposes of this disclosure are to be understood as antioxidants, thermal stabilizers or hydrolysis stabilizers. Herein stabilizers may constitute in toto up to 10 wt. % or up to 5 wt. %, based on the total weight of the composition. Standard commercial examples of stabilizers suitable for use herein include: sterically hindered phenols; thioethers; benzotriazoles; benzophenones; benzoates; cyanoacrylates; acrylates; amines of the hindered amine light stabilizer (HALS) type; phosphorus; sulfur; and, mixtures thereof.

In order to enhance shelf life even further, it is often advisable to further stabilize the compositions of the present disclosure with respect to moisture penetration through using dessicants. Examples of suitable desiccants or moisture scavengers include: silica gel; anhydrous calcium sulfate (anhydrite); calcium sulfate dihydrate (gypsum); calcium oxide; montmorillonite clay; molecular sieves, such as those including natural or synthetic zeolite; and, activated alumina.

Waxes having utility in the present disclosure can have a softening point of from about 50 to about 150° C. and may include one or more of: polyethylene having a number average molecular weight (Mn) from about 500 to about 7500; petroleum waxes, such as paraffin wax and microcrystalline wax; synthetic waxes made by polymerizing carbon monoxide and hydrogen, such as Fischer-Tropsch wax; polyolefin waxes including functionalized polyolefin waxes of which maleated polyethylene, maleated polypropylene and maleated poly(ethylene-co-propylene) may be mentioned as examples; and, hydrogenated animal, fish or vegetable oils. In various non-limiting embodiments, all values and ranges of values, both whole and fractional, including and between those set forth above are expressly contemplated for use herein.

A need also occasionally exists to lower the viscosity of the composition according to the present disclosure for specific applications, by using reactive diluent(s). The total amount of reactive diluents present will typically be from 0 to 10 wt. %, for example from 0 to 5 wt. %, based on the total weight of the composition. In various non-limiting embodiments, all values and ranges of values, both whole and fractional, including and between those set forth above are expressly contemplated for use herein.

The presence of co-solvents and non-reactive diluents in the compositions of the present disclosure is also not precluded where this can usefully moderate the viscosities thereof. For instance, but for illustration only, the compositions may contain one or more of: alkyl acetate solvents such as ethyl acetate, n-propyl acetate, butyl acetate, n-butyl acetate, propylene glycol monomethyl ether acetate and methoxypropyl acetate (MPA); alkyl propionate solvents such as n-butyl propionate and n-pentyl propionate; dibasic esters such as dimethyl succinate, dimethyl glutarate, dimethyl adipate; (di)alkyl carbonate solvents such as ethylene carbonate, propylene carbonate (PC), dimethyl carbonate (DMC), ethyl methyl carbonate (EMC) and diethyl carbonate (DEC); ethers such as tetrahydrofuran, dioxane and dimethoxyethane; glycol ether solvents such as ethylene glycol dimethyl ether, ethylene glycol diethyl ether, ethylene glycol dibutyl ether, ethylene glycol diphenyl ether, diethylene glycol, diethylene glycol-monomethyl ether, diethylene glycol-monoethyl ether, diethylene glycol-mono-n-butyl ether, diethylene glycol dimethyl ether, diethylene glycol diethyl ether, diethylene glycoldi-n-butylyl ether, propylene glycol butyl ether, propylene glycol phenyl ether, dipropylene glycol, dipropylene glycol monomethyl ether, dipropylene glycol dimethyl ether and dipropylene glycoldi-n-butyl ether; amide solvents dimethyl acetamide and N-methylpyrrolidone; ketone solvents such as acetone, diisobutyl ketone, isobutyl heptyl ketone, isophorone, methyl ethyl ketone, methyl n-amyl ketone and methyl isobutyl ketone; toluene; xylene; diphenylmethane; diisopropylnaphthalene; petroleum fractions such as Solvesso® products (available from Exxon); and, chlorohydrocarbon solvents such as 4-chlorotrifluoromethylbenzene and 3,4-bis(dichloro)trifluoromethylbenzene.

Any co-solvent(s) or non-reactive diluents of the two-part (2K) composition need not be added independently to any one or more components or to the composition itself. Alternatively one or more components of the composition may be provided in co-solvent or diluent. Any solvent or diluent included in the crosslinker part b) of the composition may be free of active hydrogen atoms in certain embodiments.

It is typical that co-solvents and non-reactive diluents constitute in toto less than 5 wt. %, in particular less than 1 wt. %, based on the total weight of the composition. The at least partial exclusion of these co-solvents and non-reactive diluents enables the two-part (2K) water-borne composition to possess a volatile organic compound (VOC) content, as measured in accordance with ISO 11890-2: 2006, of at most about 420 g/l, for instance at most about 360 g/l, such as at most about 300 g/l or even at most about 240 g/l. In various non-limiting embodiments, all values and ranges of values, both whole and fractional, including and between those set forth above are expressly contemplated for use herein.

### Methods and Applications

For the two-part (2K) curable compositions, the reactive parts are brought together and mixed in such a manner as to induce the hardening thereof. The reactive compounds can be mixed under sufficient shear forces to yield a homogeneous mixture. This can be achieved without special conditions or special equipment. That said, suitable mixing devices can include: static mixing devices; magnetic stir bar apparatuses; wire whisk devices; augers; batch mixers; planetary mixers; C.W. Brabender or Banburry® style mixers; and, high shear mixers, such as blade-style blenders and rotary impellers. In certain embodiments, once the reactive parts are mixed, one or more of water, co-solvent, non-reactive diluent may be added under mixing to moderate the viscosity of the composition.

For small-scale applications in which volumes of less than 2 liters will be used, the typical packaging for the two-part (2K) compositions will be side-by-side double cartridges or coaxial cartridges, in which two tubular chambers are arranged alongside one another or inside one another and are sealed with pistons: the driving of these pistons allows the parts to be extruded from the cartridge, advantageously through a closely mounted static or dynamic mixer. For larger volume applications, the two parts of the composition may advantageously be stored in drums or pails: in this case the two parts are extruded via hydraulic presses, in particular by way of follower plates, and are supplied via pipelines to a mixing apparatus which can ensure fine and highly homogeneous mixing of the hardener and binder parts. The binder part is typically sealed with an airtight and moisture-tight seal, so that both parts can be stored for a long time, ideally for 12 months or longer.

Non-limiting examples of two-part dispensing apparatuses and methods that may be suitable for the present disclosure include those described in U.S. Pat. Nos. 6,129,244 and 8,313,006, each of which is expressly incorporated by reference in its entirety in various non-limiting embodiments.

More typically, the above described compositions are applied to the requisite surface(s) and then cured in situ. Prior to applying the compositions, it is often advisable to pre-treat the relevant surfaces to remove foreign matter therefrom. This step can, if applicable, facilitate the subsequent adhesion of the compositions thereto. Such treatments are known in the art and can be performed in a single or multi-stage manner.

In some embodiments, the adhesion of the coating compositions to the optionally pre-treated substrate surface may be facilitated by the application of a primer thereto. Primer compositions may be necessary to ensure efficacious fixture and/or cure times of the adhesive compositions on inactive substrates.

The provision of further intermediate layers between the primer and the coating compositions of the present disclosure is not precluded, as will be described herein below with respect to multilayer coatings.

Typically the compositions are applied to the requisite surfaces of the substrate by conventional application methods such as: brushing; roll coating; doctor-blade application; printing methods; and, spraying methods, including but not limited to air-atomized spray, air-assisted spray, airless spray and high-volume low-pressure spray.

The compositions be applied to a surface at a wet film thickness of from about 10 to about 500 m. The application of thinner layers within this range is more economical and provides for a reduced likelihood of deleterious thick cured regions. However, control must be exercised in applying thinner coatings or layers so as to avoid the formation of discontinuous cured films. In various non-limiting embodiments, all values and ranges of values, both whole and fractional, including and between those set forth above are expressly contemplated for use herein.

The curing of the applied compositions typically occurs at temperatures from about 20 to about 200° C., typically from about 20 to about 160° C. The temperature that is suitable depends on the specific compounds present and the desired curing rate and can be determined in the individual case by the skilled artisan, using simple preliminary tests if necessary. For instance, in vehicle production line applications, a curing temperature of from about 80 to about 160° C. or from about 100 to about 140° C. may be effective. Conversely, for refinishing applications, a curing temperature of from about 20 to about 80° C. or from about 40 to about 60° C. may be effective. For applications to large vehicles and transportation vehicles—such as trucks, buses and railroad cars—a curing temperature of from about 20 to about 80° C. may be utilized. Of course, curing at lower temperatures within the aforementioned ranges is advantageous as it obviates the requirement to substantially heat or cool the mixture from the usually prevailing ambient temperature. Where applicable, however, the temperature of the mixture formed from the respective elements of the composition may be raised above the mixing temperature and/or the application temperature using conventional means including stoving and microwave induction. In various non-limiting embodiments, all values and ranges of values, both whole and fractional, including and between those set forth above are expressly contemplated for use herein.

The present disclosure also provides an article comprising: a metallic substrate; and, a multilayer coating disposed on the metallic substrate, wherein at least one layer of the multilayer coating comprises the cured compositions as described herein. Whilst the use of the cured compositions as an undercoat—such as a primer or sealer—within a multilayer coating is not precluded, the cured coating compositions are more suited for use in or as: a solid-color base coat; a solid-color topcoat; and/or a clear coat. For example, the cured coating composition may be used in or as a transparent clear coating.

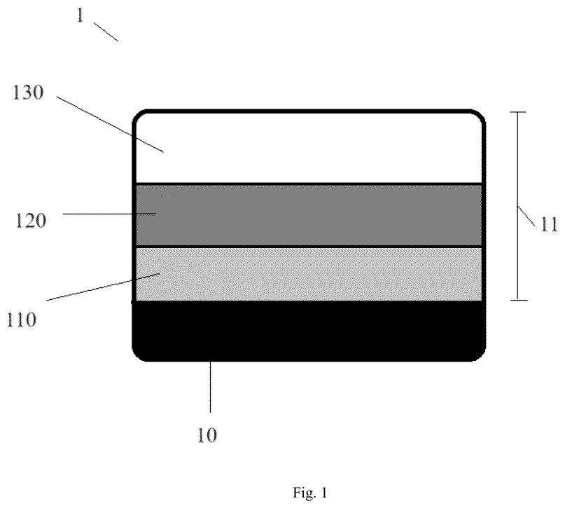

An exemplary article is illustrated in FIG. 1 appended hereto. The illustrated article (1) comprises: a metallic substrate (10); and, a multilayer coating (11) disposed on the metallic substrate, wherein the multilayer coating (11) comprises a primer layer (110) disposed on the metallic substrate; abase coat layer (120) comprising a color and/or visual effect imparting compound, wherein the base coat layer is disposed on the primer layer (110); and, a clear coat layer (130) comprising the cured product of the above-described two-part (2K) composition and which is disposed on the base coat layer (120).

The primer layer (110) is typically applied to promote adhesion between the substrate surface and the subsequent coating layers. Moreover, the primer coating layers may serve to enhance the physical properties of the overall coating system, in particular the corrosion resistance and the impact strength thereof. Still further, the primer coating layer can contribute to the overall appearance of the coating system by providing a smooth layer upon which the subsequent layers may be applied.

The primer layer (110) is depicted in FIG. 1 as being disposed on and in direct contact with the metallic substrate (10). It will however be appreciated that one or more intermediate coating layers may be disposed between the metallic substrate and the primer layer (110). A conversion coating layer is a representative example of such an intermediate coating layer. Herein the term “conversion” refers to a treatment of the surface of a substrate which causes the surface material to be chemically converted to a different material. Typically, a metal or alloyed surface substrate is chemically treated to provide a tightly adherent conversion coating, all or part of which consists of a stabilized form—for instance an oxidized form—of the substrate metal. Such chemical conversion coatings can demonstrate high corrosion resistance as well as providing a strong bonding affinity for the subsequent primer layer (110).

A single primer layer (110) is depicted in FIG. 1 for illustrative purposes only. In certain embodiments, however, more than one primer layer (110) may be present. Irrespective of whether primer is applied in a single or multilayer manner, the total thickness of the at least one primer layer may typically be from about 10 to about 200 microns, such as from about 10 to about 150 microns, from about 10 to about 75 microns or from about 20 to about 75 microns. In various non-limiting embodiments, all values and ranges of values, both whole and fractional, including and between those set forth above are expressly contemplated for use herein.

That base coat layer (120) of FIG. 1 comprises a color and/or visual effect imparting compound and is disposed on the primer layer (110). Where primer has been applied in a multilayer manner, the base coat layer is disposed on the uppermost primer layer relative to surface of the metallic substrate (10).

A single base coat layer (120) is depicted in FIG. 1 for illustrative purposes only. In certain embodiments, however, more than one base coat layer (120) may be present. The lowermost of those base coat layers may be disposed on and in direct contact with a primer layer (110). Irrespective of whether the base coat is applied in a single or multilayer manner, the total thickness of the at least one basecoat layer may typically be from about 5 to about 100 microns, such as from about 5 to about 50 microns, from about 5 to about 40 microns or from about 5 to about 30 microns. In various non-limiting embodiments, all values and ranges of values, both whole and fractional, including and between those set forth above are expressly contemplated for use herein.

In FIG. 1, a clear coat layer (130), comprising the cured product of the above-described two-part (2K) composition, is disposed on the base coat layer (120). Where the base coat has been applied in a multilayer manner, the clear coat layer (130) would be disposed on the uppermost base coat layer relative to surface of the metallic substrate (10). The clear coat layer (130) typically possesses good chemical resistance as well as resistance to mechanical wear and weathering. Further, the clear coat layer (130) will have satisfactory optical properties, including transparency and gloss.

Again, a single clear coat layer (130) is depicted in FIG. 1 for illustrative purposes only. In certain embodiments, however, more than one clear coat layer (130) may be present. The lowermost of those clear coat layers may be disposed on and in direct contact with the base coat layer (120). Irrespective of whether the clear coat is applied in a single or multilayer manner, the total thickness of the at least one clear coat layer may typically be from about 10 to about 500 microns, such as from about 10 to about 200 microns, from about 20 to about 100 microns or from about 30 to about 90 microns. In various non-limiting embodiments, all values and ranges of values, both whole and fractional, including and between those set forth above are expressly contemplated for use herein.

The or each clear coat layer (130) of the article may typically be at least substantially transparent to visible light. Thus, for example, the or each clear coat layer may be at least about 85%, at least about 90% or at least about 95% transparent to visible light, as determined using transmittance (TR) measurements in accordance with ASTM D1746 (2023).

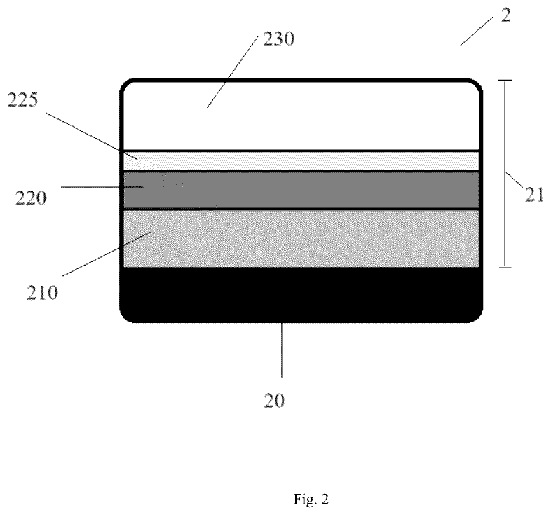

A further exemplary article is illustrated in FIG. 2 appended hereto. The illustrated article (1) comprises: a metallic substrate (20); and, a multilayer coating (21) disposed on the metallic substrate, wherein the multilayer coating (21) comprises a primer layer (210) disposed on the metallic substrate; a base coat layer (220) comprising a color and/or visual effect imparting compound, wherein the base coat layer is disposed on the primer layer (210); a tie layer (225 disposed on the base coat layer (220); and, a clear coat layer (230) comprising the cured product of the above-described two-part (2K) composition and which is disposed on the tie layer (225).

The tie layer (225) can be interposed between—and can enhance the adhesion of—a base coat layer (220) and a clear coat layer (230). Given this interposition, the tie layer (225) may typically be substantially transparent to visible light. Thus, for example, the tie layer (225) layer may be at least about 85%, at least about 90% or at least about 95% transparent to visible light, as determined using transmittance (TR) measurements in accordance with ASTM D1746 (2023). In various non-limiting embodiments, all values and ranges of values, both whole and fractional, including and between those set forth above are expressly contemplated for use herein.

A single tie layer (225) is depicted in FIG. 2 for illustrative purposes only. In certain embodiments, however, more than one tie layer (225) may be present. The lowermost of those tie layers may be disposed on and in direct contact with the base coat layer (220); a clear coat layer (230) comprising the cured product of the above-described two-part (2K) composition would be disposed on and in direct contact with the uppermost of the tie layers (225) in these embodiments. The total thickness of the at least one tie layer may in embodiments be less than the total thickness of the clear coat layer(s) (230). Alternatively or additionally, the total thickness of the at least one tie layer may be from about 1 to about 50 microns, such as from about 1 to about 25 microns, from about 5 to about 25 microns or from about 5 to about 20 microns. In various non-limiting embodiments, all values and ranges of values, both whole and fractional, including and between those set forth above are expressly contemplated for use herein.

The process of forming a multilayer coating will conventionally incorporate the steps of: i) providing a metallic substrate; ii) applying a first layer of a first curable coating composition on and in direct contact with the metallic substrate; iii) at least partially curing that first layer; iv) applying a second layer of a second curable coating composition on and in direct contact with the at least partially cured first layer; v) at least partially curing that second layer; vi) applying a third layer of a third curable coating composition on and in direct contact with the at least partially cured second layer; and, vii) at least partially curing that third layer. In an iterative process, steps vi) and vii) may be performed and repeated so as to dispose fourth and further layers on the metallic substrate. Having regard to the multilayer coatings illustrated in FIGS. 1 and 2, the first, second, third and further curable compositions provide: at least one primer layer; at least one base coat layer; optionally at least one tie layer; and, at least one clear coat layer as described above.

The metallic substrate provided in step i) may typically be pre-treated prior to step ii). Such pre-treatment may comprise at least one of: cleaning the surface(s) of the metallic substrate; abrading the surface(s) of the metallic substrate; applying an anti-corrosion coating to the metallic substrate; or, applying a conversion coating to the metallic substrate, as mentioned above.

Cleaning serves to remove foreign matter from the surface(s) of the metallic substrate. Cleaning treatments are known in the art and can be performed in a single or multi-stage manner constituted by, for instance, the use of one or more of: an etching treatment with an acid suitable for the substrate and optionally an oxidizing agent; sonication; plasma treatment, including chemical plasma treatment, corona treatment, atmospheric plasma treatment and flame plasma treatment; immersion in a waterborne alkaline degreasing bath; treatment with a waterborne cleaning emulsion; treatment with a cleaning solvent, such as carbon tetrachloride or trichloroethylene; and, water rinsing, preferably with deionized or demineralized water. In those instances where a waterborne alkaline degreasing bath is used, any of the degreasing agent remaining on the surface should typically be removed by rinsing the substrate surface with deionized or demineralized water.

Independently of the cleaning of the substrate, the surface of the metallic substrate (10) may be abraded. Abrading typically includes sanding which may be performed using, for instance, an orbital sander having sandpaper of a pre-determined grit. After surface abrasion, the metallic substrate may optionally be cleaned to remove any dust generated during the abrasion operation or any other acquired dirt or contaminants.

As used in the described process, the term “at least partially cured” means that curing of the curable coating composition has been initiated and that, for example, cross-linking of components of the composition has commenced. The term encompasses any amount of cure upon application of the curing condition, from the formation of a single cross-link to a fully cross-linked state. The rate and mechanism with which the coating composition cures is contingent on various factors, including the components thereof, functional groups of the components and the parameters of the curing condition.

At least partial solidification of a given coating layer is generally indicative of cure or drying. However, both drying and cure may be indicated in other ways including, for instance, a viscosity change of the coating layer, an increased temperature of that coating layer and/or a transparency/opacity change of that coating layer.

It may be typical for steps iv) and vi) of the above described application process to be commenced only when the at least partially cured or partially dried preceding layer can substantially retain its shape upon exposure to ambient conditions. By “substantially retain its shape” is meant that at least about 50% by volume, and more usually at least about 80% or about 90% by volume of the at least partially cured or dried layer retains its shape and does not flow or deform upon exposure to ambient conditions for a period of 5 minutes. Under such circumstances, gravity typically may not substantially impact the shape of the at least partially cured or partially dried layer upon exposure to ambient conditions.

The shape of the at least partially dried or at least partially cured layer may typically impact whether the layer substantially retains its shape. For example, when the layer is rectangular or has another simplistic shape, the at least partially cured or dried layer may be more resistant to deformation at even lesser levels of cure or even lesser degrees of drying than layers having more complex shapes.

In certain embodiments, the application of each subsequent layer (step iv); step vi)) occurs before an at least partially cured layer has reached a final cured state, nominatively while the layer is still “green”. In such embodiments, application of the layers may be considered “wet-on-wet” such that the adjacent layers at least physically bond, and may also chemically bond, to one another. For example, it is possible that components in each of the first and subsequent layers can chemically cross-link/cure across the application line, which effect can be beneficial to the longevity, durability and appearance of the finished article. The distinction between partial cure and a final cured state is whether the partially cured layer can undergo further curing or cross-linking. This does not actually preclude functional groups being present in the final cure state but such groups may remain un-reacted due to steric hindrance or other factors.

In the aforementioned iterative process, the thickness, width, shape and continuity of each layer may be independently selected such that the preceding and subsequent layer may be the same or different from one another in one or more of these regards. For example, a given subsequent layer may only contact a portion of an exposed surface of the at least partially cured or dried preceding layer: depending on the desired shape of the coating layer, the subsequent layer may build on that layer selectively.

The following examples are illustrative of the present disclosure and are not intended to limit the scope of the disclosure in any way.

### EXAMPLES

The following commercial products are employed in the Examples below:
CE10P: Cardura E10P; versatic acid glycidylester, available from Hexion.
BYK® 345: Silicone surfactant, available from Altana.
BYK® 333: Silicone-containing surface additive, available from Altana.
Tinuvin® 292: Hindered amine light stabilizer, available from BASF.
Tinuvin® 1130: UV absorber of the hydroxyphenyl benzotriazole class, available from BASF.
EmpolS: Fatty acid dimer, available from Henkel Corporation.
Bayhydur XP2655: Hydrophilic aliphatic polyisocyanate based on hexamethylene diisocyanate (HDI), available from Covestro AG.
Desmodur® N 3900: Hexamethylenediisocyanate trimer, available from Covestro AG.
Unless otherwise stated, all remaining compounds may be obtained from Sigma Aldrich.

### RSE1: Reference Synthesis Example 1

In a reactor equipped with a propeller-type stirrer, a thermometer, condenser and monomer/initiator feeding system, 385 grams of CE10P and 75 grams of ethoxypropanol were loaded and heated to about 150° C. A mixture of 103 grams of hydroxyethylmethacrylate, 507 grams of styrene, 136 grams of acrylic acid, 18 grams of dicumylperoxide, 77 grams of CE10P and 88 grams of ethoxypropanol were added over 2.5 hours to the reactor whilst maintaining the contents at 150° C. After the feed, the reactor contents were held for 30 minutes.

After this hold period, 175 grams of hydroxyethylmethacrylate, 49 grams of acrylic acid, 230 grams of isobutyl methacrylate (IBMA), 7.3 grams of dicumylperoxide and 102 grams of ethoxypropanol were added over 2.5 hours whilst maintaining the contents at 150° C. This addition was followed by a rinsing step for the feed system using 58 grams of ethoxypropanol. After the rinsing step, the contents of the reactor were held for 2 hours at 150° C.

The reactor contents were cooled to 100° C. and 177 grams of ethoxypropanol were distilled off. 54 grams of dimethylaminoethanol (DMEA) were added to the contents, after which the obtained polymer blend was diluted with 1850 grams of water preheated to about 70° C.

The measured properties of the obtained dispersion were as follows: solids content, 45.1 wt. %; viscosity, 4500 centipoise; acid value, 27.8 mg KOH/g; and, pH, 8.0. In a visual determination of stability, the obtained aqueous dispersion demonstrated 4 weeks without sedimentation when stored at 60° C.

The molecular weights of the synthesized copolymer, as determined by gel permeation chromatography (GPC) using polystyrene calibration standards in accordance with ASTM 3536 were: number average molecular weight (Mn) of 5300 Daltons; and, weight average molecular weight (Mw) of 32800 Daltons

### RSE2: Reference Synthesis Example 2

Following the process of Reference Synthesis Example 1 (RSE1) and increasing the initiator loading on both stages by 50% while employing the same loading for other materials; dispersions of hydroxyl functional (meth)acrylate copolymers with lower molar mass were prepared.

The molecular weights of the synthesized copolymer, as determined by gel permeation chromatography (GPC) using polystyrene calibration standards in accordance with ASTM 3536 were: number average molecular weight (Mn) of 4200 Daltons; and, weight average molecular weight (Mw) of 17556 Daltons.

In a visual determination of stability, the obtained aqueous dispersion demonstrated sedimentation when stored at 60° C. for less than 4 weeks. Due to the insufficient stability, further evaluation of the synthesized copolymer was not pursued.

### SE1: Synthesis Example 1

In a reactor equipped with a propeller-type stirrer, a thermometer, condenser and monomer/initiator feeding system, 385 grams of CE10P and 75 grams of ethoxypropanol were loaded and heated to about 150° C. A mixture of 103 grams of hydroxyethylmethacrylate, 217 grams of styrene, 136 grams of acrylic acid, 250 grams of isobornyl methacrylate, 18 grams of dicumylperoxide, 77 grams of CE10P and 88 grams of ethoxypropanol were added over 2.5 hours to the reactor whilst maintaining the contents at 150° C. After the feed, the reactor contents were held for 30 minutes.

After this hold period, 170 grams of hydroxyethylmethacrylate, 47.5 grams of acrylic acid, 222 grams of isobutyl methacrylate (IBMA), 7.3 grams of dicumylperoxide and 102 grams of ethoxypropanol were added over 2.5 hours whilst maintaining the contents at 150° C. This addition was followed by a rinsing step for the feed system using 58 grams of ethoxypropanol. After the rinsing step, the contents of the reactor were held for 2 hours at 150° C.

The reactor contents were cooled to 100° C. and 190 grams of ethoxypropanol were distilled off. 52 grams of dimethylaminoethanol (DMEA) were added to the contents, after which the obtained polymer blend was diluted with 1805 grams of water preheated to about 70° C.

The measured properties of the obtained dispersion were as follows: solids content, 45.1 wt. %; viscosity, 3800 centipoise; acid value, 27.8 mg KOH/g; and, pH, 7.8. In a visual determination of stability, the obtained aqueous dispersion demonstrated 4 weeks without sedimentation when stored at 60° C.

The molecular weights of the synthesized copolymer, as determined by gel permeation chromatography (GPC) using polystyrene calibration standards in accordance with ASTM 3536 were: number average molecular weight (Mn) of 4300 Daltons; and, weight average molecular weight (Mw) of 16600 Daltons Synthesis Example 2: Preparation of a solution of a polyester polyol (PE1)

A mixture of 911 g of trimethylol propane, 748 g of hexahydrophthalic anhydride and 138 g of dimer fatty acid (EmpolS) 1008 from Henkel was heated to 250° C. Esterification was carried out with water separation until an acid value of less than 5 mg KOH/g was obtained. After the reaction mixture was cooled to below 125° C., the solids content was adjusted to 70 wt. % with 90 g of xylene and 641 g of methoxypropyl acetate.

The obtained polyester polyol had a calculated hydroxyl value of 345 mg KOH/g and an acid value of 4.5 mg KOH/g. The calculated hydroxyl functionality was 5.6 and the calculated number average molecular weight (Mn), as determined by gel permeation chromatography (GPC) using polystyrene calibration standards in accordance with ASTM 3536, was 920 Daltons.

### Example 1

The above described dispersions (RSE1, SE1, PE1) were used to prepare two-part (2K) clear coating compositions. Part a) of the two-part compositions was obtained by mixing the components given in Table 1 hereinbelow. Similarly, part b) of the two-part composition was obtained by blending Desmodur® N 3900 and butyl glycol acetate in the amounts shown. The Table details the preparation of: four Reference Coating Compositions (RCC1-RCC4); and two coating compositions (CC1-CC2) in accordance with the present disclosure.

TABLE 1

| | RCC1 | RCC2 | RCC3 | RCC4 | CC1 | CC2 |
|---|---|---|---|---|---|---|
| | (parts by | (parts by | (parts by | (parts by | (parts by | (parts by |
| Ingredient | weight) | weight) | weight) | weight) | weight) | weight) |
| Part a) | | | | | | |
| Acrylic Copolymer | 92.27 | | 82.40 | 82.15 | | |
| Dispersion (RSE1) | | | | | | |
| Acrylic Copolymer | | 92.27 | | | 82.40 | 82.15 |
| Dispersion (SE1) | | | | | | |
| Polyester Example B | | | 5.47 | 5.45 | 5.47 | 5.45 |
| 2-Ethylhexane-1,3-diol | | | | 2.02 | | 2.02 |
| Propylene Glycol Methyl | 1.31 | 1.31 | 1.01 | 1.31 | 1.01 | 1.31 |
| Ether | | | | | | |
| Butyl glycol acetate | 0.51 | 0.51 | 0.51 | 0.50 | 0.51 | 0.50 |
| Mineral Spirits | 1.62 | 1.62 | 1.62 | 1.61 | 1.62 | 1.61 |
| N,N-dimethylethanolamine | 0.00 | 0.00 | 0.14 | 0.14 | 0.14 | 0.14 |
| Deionized Water | 2.02 | 2.02 | 6.58 | 4.54 | 6.58 | 4.54 |
| Byk 345 | 0.58 | 0.58 | 0.58 | 0.58 | 0.58 | 0.58 |
| Byk 333 | 0.19 | 0.19 | 0.19 | 0.19 | 0.19 | 0.19 |
| Tinuvin 292 | 0.66 | 0.66 | 0.66 | 0.66 | 0.66 | 0.66 |
| Tinuvin 1130 | 0.85 | 0.85 | 0.85 | 0.85 | 0.85 | 0.85 |
| Total Weight of Part a) | 100.00 | 100.00 | 100.00 | 100.00 | 100.00 | 100.00 |
| Part b) | | | | | | |
| Desmodur ®N 3900 | 47.3 | 47.3 | 47.3 | 47.3 | 47.3 | 47.3 |
| Bayhydur XP2655 | 23.8 | 23.8 | 23.8 | 23.8 | 23.8 | 23.8 |
| Butyl glycol acetate | 23.7 | 23.7 | 23.7 | 23.7 | 23.7 | 23.7 |
| Mineral Spirits | 5.2 | 5.2 | 5.2 | 5.2 | 5.2 | 5.2 |
| Total Weight of Part b) | 100.0 | 100.0 | 100.0 | 100.0 | 100.0 | 100.0 |

The respective parts a) and b) given above were mixed at a ratio by weight (a:b) of 100:35 to form coating compositions (RCC1-4, CC1-CC2), each composition having a molar ratio of active hydrogen atoms to —NCO groups (herein OHINCO) of from 0.7:1 to 1.4:1. The viscosity of each composition was adjusted using deionized water to a viscosity of 20 to 28 cps, as determined at room temperature using a Brookfield CAP2000 Viscometer (400 rpm, Spindle No. 4). The thus obtained clear coat coating compositions were each sprayed onto black coated steel panels and baked for 30 minutes at 60° C. The following evaluative tests were then performed on the obtained coatings and the results provided in Table 2 herein below.

Wave-Scan: Wave scanning, which is intended to simulate visual perception, was performed using a Wavescan-DOI available from BYK-Gardner GmbH. The instrument provided a laser point light source which illuminated the specimen at a 60° angle: an associated detector measured the reflected light intensity at the equal but opposite angle. The longwave signal (structure size >0.6 mm) and shortwave signal (structure size <0.6 mm) were each divided from the measured signal using a mathematical filter function. The meter was rolled across the surface and measured, point-by-point, the optical profile of the surface across a defined distance. The long-term waviness value as provided in Table 2 represents the variance of the longwave signal amplitude and has been normalized to a unitless value in the range of from 0 to 100, wherein 0 depicts the lowest variance (best) and 100 depicts the highest variance (worst). Similarly, the short-term waviness value represents the variance of the shortwave signal amplitude and has been normalized to a unitless value in the range of from 0 to 100, wherein 0 depicts the lowest variance (best) and 100 depicts the highest variance (worst).

Distinctness of Image (DOI): This is a measure of how crisp and sharply a reflected image appears in the applied coating and was determined herein using ASTM D5767-18 Standard Test Method for Instrumental Measurement of Distinctness-of-Image (DOI) Gloss of Coated Surfaces. The scale values obtained with the measuring procedures of this test method range from 0 to 100, with a value of 100 representing perfect DOI (image clarity). As the value decreases from 100, the image becomes more distorted.

Jacksonville Etch Rating: The etch rating of the clear coats was determined exposing five (5) replicates of the clear coated steel panels (30 cm×30 cm) to an exposure site at Blount Island, Jacksonville, Florida (USA). The exposure lasted from the end of May to the end of August. The defects were rated by a grade scale ranging from 1 (no visible etching) to 10 (severe etching) as detailed in GM Material Specification 9984157 (2009). The grades of the five replicates were averaged to obtain the etch rating values provided in Table 2 below.

TABLE 2

| Tested Property | RCC1 | RCC2 | RCC3 | RCC4 | CC1 | CC2 |
|---|---|---|---|---|---|---|
| Distinctiveness of Image (DOI) | 95.5 | 95.8 | 96.5 | 96.5 | 96.7 | 96.9 |
| Long-Term Waviness Value | 4 | 3.8 | 4.8 | 1.7 | 3.4 | 1.5 |
| Short-Term Waviness Value | 2.4 | 2.1 | 2.2 | 1.6 | 2.0 | 1.4 |
| Jacksonville etch rating | 7.5 | 6.9 | 7.0 | 7.2 | 6.1 | 6.4 |

As compared to Reference Coating Composition RCC1 and RCC2, the addition of the polyester resin to CC1 yielded improved an appearance, as reflected by the lower short wave value and higher DOI value given in Table 2. Moreover, CC1 exhibited improved Jacksonville etch resistance.

As compared to Reference Coating Composition RCC3 and RCC4, the methacrylate copolymers used in CC1 and CC2 yielded improved appearance respectively, as reflected by the lower short wave value and higher DOI value given in Table 2. Moreover, CC1 and CC2 exhibited improved Jacksonville etch resistance.

The presence of the low molecular weight diol in combination with the polyester resin in the coating composition CC2 promotes an improvement in both of the long-term and short-term waviness values, without compromising the distinctiveness of image results or significantly compromising etch resistance.

It can be understood that various changes and modifications to the exemplary embodiments described herein will be apparent to those skilled in the art. Such changes and modifications can be made without departing from the spirit and scope of the present subject matter and without diminishing its intended advantages. It is therefore intended that such changes and modifications be covered by the appended claims. Also, it can be appreciated that the features of the dependent claims may be embodied in the compositions and methods of each of the independent claims.

Many modifications to and other embodiments of the disclosure set forth herein will come to mind to one skilled in the art to which this disclosure pertains, once having the benefit of the teachings in the foregoing description. Therefore, it is understood that the disclosure is not limited to the specific embodiments disclosed, and that modifications and other embodiments are intended to be included within the scope of the appended claims.

What is claimed is:

1. A two-part (2K) water-borne coating composition comprising
water;
a) a binder part comprising:
(a1) at least one hydroxyl-functional (meth)acrylate copolymer; and,
(a2) at least one non-aromatic polyester having active hydrogen groups; and,
b) a crosslinker part comprising:
at least one polyisocyanate compound having pendant —NCO groups,
wherein the molar ratio of active hydrogen atoms to —NCO groups in the composition is from 5:1 to 1:5;
wherein the (a2) non-aromatic polyester has a number average molecular weight (Mn) of from about 500 to about 5000 Daltons, an acid value from about 0 to about 30 mg KOH/g, a calculated hydroxyl value of from about 100 to about 600 mg KOH/g and a calculated hydroxyl functionality of from about 2 to about 8; and,
wherein the (a1) (meth)acrylate copolymer is the reaction product of monomers in a monomer mixture which comprises, based on the total weight of monomers:
from about 20 to about 60 wt. % of i) at least one hydroxyl functional adduct of a monoepoxyester and an unsaturated carboxylic acid;
from about 10 to about 30 wt. % of ii) at least one hydroxyl functional unsaturated monomer which is different from component i);
from about 2 to about 6 wt. % of iii) at least one unsaturated acid functional monomer; and,
from about 20 to about 60 wt. % iv) at least one (meth)acrylate monomer represented by Formula MA:
H₂C═CG^{a}CO₂R^{a} (MA)
wherein: G^{a} is hydrogen, halogen or methyl; and,
R^{a} is: C₁-C₁₈ alkyl; C₂-C₁₈ heteroalkyl; C₃-C₁-C₁₈ cycloalkyl; C₂-C₁₈ heterocycloalkyl; C₂-C₁₈ alkenyl, or, C₂-C₁₈ alkynyl;
from about 0 to about 15 wt. % of v) at least one vinyl aromatic monomer; and,
from about 0 to about 20 wt. % of vi) at least one polymerizable unsaturated monomer that is different from i) to v).

2. The coating composition according to claim 1, wherein the ratio by weight of solids of (a1) to solids of (a2) is from about 100:1 to about 100:35.

3. The coating composition according to claim 1 having a volatile organic compound (VOC) content, as measured in accordance with ISO 11890-2: 2006, of at most about 420 g/l.

4. The coating composition according to claim 1, wherein the (meth)acrylate monomer of Formula (MA), if homopolymerized, yields a homopolymer having a glass transition temperature (Tg) of greater than about 30° C.

5. The coating composition according to claim 4, wherein the at least one (meth)acrylate monomer chosen from: cyclohexyl (meth)acrylate; 3,3,5-trimethylcyclohexyl (meth)acrylate; isobornyl (meth)acrylate; norbornyl (meth)acrylate; dihydrodicyclopentandienyl (meth)acrylate; 4-tert-butyl cyclohexyl (meth)acrylate; and, mixtures thereof.

6. The coating composition according to claim 1, wherein v) is present in an amount of from about 4 to about 14 wt. % of the total weight of monomers in the monomer mixture.

7. The coating composition according to claim 1, wherein the at least one vinylaromatic monomer of v) has the Formula (VA): 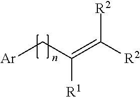
wherein: R¹ is H or C₁-C₄ alkyl;
each R² is independently hydrogen or C₁-C₄ alkyl;
Ar is unsubstituted phenyl or phenyl substituted with from 1 to 5 substituents, wherein each substituent is independently halogen or C₁-C₄ alkyl; and,
n is an integer from 0 to 4.

8. The coating composition according to claim 7, wherein v) comprises at least one monomer chosen from: styrene; α-methylstyrene; 2-methylstyrene; 3-methylstyrene; 4-methylstyrene; 2-tert-butyl styrene; 4-tert-butylstyrene; 2-chlorostyrene; 4-chlorostyrene; and, mixtures thereof.

9. The coating composition according to claim 1, wherein at least one monomer of the monomer mixture has the formula AM1:
R⁴—C(H)═C(R⁵)-A-(R⁶O)_{[a]}—R⁷ (AM1)
wherein: R⁴ is H, methyl, CO₂H or CH₂CO₂H;
R⁵ is hydrogen, halogen or methyl;
A is —CH₂C(O)O—, —C(O)O—, —O—, —CH₂O—, —CH₂C(O)N—, —C(O)N—, —CH₂—, —O—C(O)—, —NHC(O)O—, —NHC(O)NH—, —C₆H₄(R′)—NH—C(O)—O—, —C₆H₄(R′)—NH—C(O)—NH—, —C(O)O—CH₂—CH(CH₂OH)—O—, —C(O)O—CH₂—CH(CH₂OH)—NH—, —C(O)O—CH₂—CH₂—CH(OH)—O—, —C(O)O—CH₂—CH₂—CH(OH)—NH—, —CH₂—O—CH₂—CH(CH₂OH)—O—, —CH₂—O—CH₂—CH₂—CH(OH)—O—, —CH₂—O—CH₂—CH(CH₂OH)—NH—, or —CH₂—O—CH₂—CH₂—CH(OH)—NH—;
each R⁶ is independently C₂-C₄ alkylene;
[a] has a value of from about 5 to about 100;
R⁷ is C₁-C₃₀ alkyl, C₁-C₃₀ hydroxyalkyl, C₁-C₃₀ aminoalkyl, C₃-C₁₈ cycloalkyl, C₂-C₅heterocycloalkyl, C₂-C₂₀ alkenyl, C₂-C₁₂ alkynyl, C₆-C₁₈ aryl, C₇-C₂₄ alkaryl or C₇-C₂₄ aralkyl; and,
R⁸ is —CH₂— or —(C)(CH₃)₂—.

10. The coating composition according to claim 9, wherein:
R⁴ is H, methyl, CO₂H or CH₂CO₂H;
R⁵ is hydrogen, halogen or methyl;
A is —CH₂C(O)O— or —C(O)O—;
each R⁶ is independently C₂-C₄ alkylene;
[a] has a value of from about 10 to about 30; and,
R⁷ is C₆-C₃₀ alkyl, C₆-C₃₀ hydroxyalkyl, C₆-C₃₀ aminoalkyl, C₃-C₁₈ cycloalkyl, C₆-C₁₈ aryl, C₇-C₁₈ alkaryl or C₇-C₁₈ aralkyl.

11. The coating composition according to claim 9, wherein the monomer having the formula AM1 is chosen from: lauryl ethoxylate [a] (meth)acrylate; cetyl ethoxylate [a] (meth)acrylate; stearyl ethoxylate [a] (meth)acrylate; behenyl ethoxylate [a] (meth)acrylate; lauryl ethoxylate [a] itaconate; cetyl ethoxylate [a] itaconate; stearyl ethoxylate [a] itaconate; behenyl ethoxylate [a] itaconate; lauryl ethoxylate [a] maleate; cetyl ethoxylate [a] maleate; stearyl ethoxylate [a] maleate; behenyl ethoxylate [a] maleate; and, mixtures thereof,
wherein [a] represents the number of moles of ethoxylation and has a value of from about 10 to about 30.

12. The coating composition according to claim 1, wherein the (a1) hydroxyl-functional (meth)acrylate copolymer is prepared from the monomer mixture by a skew feed polymerization process with at least two feed monomer streams; and,
further wherein one feed stream comprises:
I) from about 60 to about 100% by weight of the total amount of i) in the monomer mixture;
II) from about 0 to about 60% by weight of the total amount of ii) in the monomer mixture;
III) from about 0 to about 30% by weight of the total amount of iii) in the monomer mixture; and,
IV) from about 0 to about 80% by weight of the total amount of iv) in the monomer mixture;
V) from about 0 to about 100% by weight of the total amount of v) in the monomer mixture; and,
VI) from about 0 to about 100% by weight of the total amount of vi) in the monomer mixture, wherein the remaining one or more feed streams comprise the balance of i) to vi).

13. The coating composition according to claim 1, wherein the (a2) non-aromatic polyester has:
a number average molecular weight (Mn) of from about 500 to about 1500 Daltons;
an acid value from about 0 to about 30 mg KOH/g;
a calculated hydroxyl value of from about 250 to about 400 mg KOH/g; and,
a calculated hydroxyl functionality of from about 4 to about 8.

14. The coating composition according to claim 1, wherein the (a2) non-aromatic polyester is obtained by the polycondensation reaction of:
at least one hydroxyl functional component (a2h);
at least one carboxyl functional component (a2c); and, optionally
at least one hydroxycarboxylic acid component (a2hc),
wherein the polycondensation reaction utilizes a stoichiometric excess of hydroxyl groups to carboxyl groups.

15. The coating composition according to claim 14, wherein:
the hydroxyl functional component (a2h) comprises, based on the weight of the hydroxyl functional component:
from about 75 to about 100 wt. % of at least one polyol having from 3 to 6 hydroxyl groups; and,
from about 0 to about 25 wt. % of at least one diol; and,
the carboxyl functional component (a2c) comprises, based on the weight of the carboxyl functional component:
from about 75 to about 100 wt. % of at least one dicarboxylic acid; and,
from about 0 to about 25 wt. % of at least one monocarboxylic acid.

16. The coating composition according to claim 1, wherein part a) further comprises in an amount up to 20 wt. %, based on the weight of (a1):
(a3) at least one (meth)acrylate polymer having active hydrogen groups which is distinct from the hydroxyl-functional (meth)acrylate polymer(s) of (a1), wherein (a3) has a water solubility at about 20° C. of less than about 6 g/100 ml of water.

17. The coating composition according to claim 16, wherein the (meth)acrylate polymer of (a3) has:
a calculated hydroxyl value of from about 100 to about 600 mg KOH/g;
an acid value of from about 0 to about 35 mg KOH/g; and,
a number average molecular weight of from about 1000 to about 4000 Daltons.

18. A cured product obtained from the water-borne coating composition of claim 1.

19. An article comprising:
a metallic substrate; and,
a multilayer coating disposed on the metallic substrate, wherein at least one layer of the multilayer coating comprises the cured product of claim 18.

20. The article according to claim 19, wherein the multilayer coating comprises:
a primer layer disposed on and in direct contact with the substrate;
at least one base coat layer comprising a color and/or visual effect imparting compound, wherein at least one base coat layer is disposed on and in direct contact with the primer layer; and,
a clear coat layer comprising the cured product of claim 18 and disposed on and in direct contact with at least one base coat layer.
